(19) United States
(12) Patent Application Publication
(10) Pub. No.: US 2010/0327175 A1
(43) Pub. Date: Dec. 30, 2010

(54) PHASE-CONTRAST IMAGING METHOD AND APPARATUS

(76) Inventors: Yakov Nesterets, Victoria (AU); Stephen William Wilkins, Victoria (AU)

Correspondence Address: BRINKS HOFER GILSON & LIONE, P.O. BOX 10395, CHICAGO, IL, 60610, US

(21) Appl. No.: 12/747,869

(22) PCT Filed: Nov. 28, 2008
(86) PCT No.: PCT/AU08/01766

§ 371 Date: Sep. 2, 2010

(30) Foreign Application Priority Data
Dec. 14, 2007 (AU) 2007906826

(51) Int. Cl. G01J 1/42

(52) U.S. Cl. 250/393

(57) ABSTRACT

A phase-contrast imaging apparatus for imaging an object, comprising a radiation source, a first diffracting optical element located to receive radiation from the source, a second diffracting optical element located after the first optical element, a spatially resolving detector for detecting radiation from the source that has propagated through the object and been diffracted sequentially by the first optical element and the second optical element and an actuator for providing a relative translation of the first and second optical elements with respect to and across a propagation direction of radiation transmitted from the source to the detector. The actuator provides the relative translations of the first and second optical element at respectively a first speed and a second speed that is the first speed times a magnification factor of the apparatus.

### RELATED APPLICATION

This application is based on and claims the benefit of the filing date of AU application no. 2007906826 filed 14 Dec. 2007, the content of which as filed is incorporated herein by reference in its entirety.

### FIELD OF THE INVENTION

The present invention relates to a phase-contrast imaging method and apparatus, of particular but by no means exclusive application in phase-contrast imaging using x-rays or neutrons.

### BACKGROUND OF THE INVENTION

The most long-standing method for X-ray imaging (i.e. radiography) is based on absorption and dates back to the pioneering work of Röntgen (who discovered X-rays in 1895). More recently, other mechanisms for X-ray imaging have been developed including those involving phase contrast. These methods are sensitive to the real part of the complex refractive index for the interaction between electromagnetic radiation and matter. They also depend on the use of wave optics for their proper description (cf. conventional radiography, based on simple geometrical optics).

Existing X-ray phase-contrast imaging methods can be classified according to sensitivity to phase variations in the detected object wave, as follows:

1) X-ray interferometry [1-3] which is sensitive to the phase itself but modulo 2π;
2) Differential phase-contrast methods, including analyser-based imaging (ABI) [4-9] and grating-based imaging [10-18], which are sensitive to the derivative of the phase in a certain direction or to the phase gradient; and
3) Propagation-based imaging (PBI) [19-22] where the image contrast is proportional to the two-dimensional (2D) Laplacian of the phase, at least in the near-field regime.

Of these, X-ray interferometry has high sensitivity to the phase shift (and can achieve sensitivity in Δρ/ρ of the order of 10⁻⁹). However, it typically requires highly monochromatic radiation (of Δλ/λ ˜10⁻⁴), precise alignment of the crystals (being highly susceptible to mechanical and thermal instabilities). Also, interferograms are difficult to interpret and typically require more than one interferogram to be recorded for a given sample because of the modulo 2π ambiguity. Image processing is required for visualisation of phase, and severe practical difficulties arise when imaging even moderately thick objects.

Analyser-based imaging has high sensitivity to the phase gradient, images are easy to interpret (with no need for processing) and dark-field imaging is possible. However, analyser-based imaging typically uses quasi-monochromatic radiation (of Δλ/λ ˜10⁻⁴), and is usually sensitive to only one component of the phase gradient leading to possible ambiguities in phase estimation. It also requires an effectively perfect analyser crystal that itself must be very precisely controlled in orientation; although bent-crystal optics can help to overcome some limitations, their use can lead to other complications. In addition, spatial resolution is limited by the extinction length of the analyser so, to improve spatial resolution, asymmetric reflections (grazing incidence) for the analyser crystal are often used.

Grating-based imaging has high sensitivity to the phase gradient and images are comparatively easy to interpret (when using two gratings) provided the spatial resolution of the detector is not too high. Also, moderate polychromaticity is allowed (Δλ/λ ˜0.1 [17] or even Δλ/λ ˜1 [27]) and dark-field imaging is possible. However, grating-based imaging is sensitive to only one component of the phase gradient, requires precise alignment of the gratings at a significant separation distance (in two grating modality) and requires gratings with a small period (of the order of several microns) and high aspect ratio of the lines in the gratings, especially at high photon energies. Furthermore, the spatial resolution of the system may in practice be deliberately decreased relative to Talbot fringe spacing at the detector (in the known two grating modality [10,11]) or several images are collected using a high-resolution detector with further processing of data (single grating modality [18]), and may involve ambiguities in phase determination. The requirement to collect multiple images in this method in a short-time frame for imaging studies on dynamic systems (such as in clinical medical imaging) imposes severe design and technical performance constraints on suitable detectors for use in applying this method. Ultimately, spatial resolution in the images is typically limited either by detector resolution or by the period of the Talbot self-image.

Propagation-based imaging has high sensitivity to abrupt phase changes (viz. edge enhancement), permits significant polychromaticity (Δλ/λ ˜1), is two-dimensional, easy to interpret and has the simplest setup (with no need for optical elements between object and detector). Also, it can be used to achieve very high spatial resolution. However, propagation-based imaging requires a high transverse coherence (so a distant or small source), and provides poorer contrast than do other imaging methods.

### SUMMARY OF THE INVENTION

According to a first broad aspect, the present invention provides a phase-contrast imaging apparatus for imaging an object, comprising:
a radiation source;
a first diffracting optical element located to receive radiation from the source;
a second diffracting optical element located after the first optical element;
a spatially resolving detector for detecting radiation from the source that has propagated through the object and been diffracted sequentially by the first optical element and the second optical element; and
an actuator for providing a relative translation of the first and second optical elements with respect to and across a propagation direction of radiation transmitted from the source to the detector;
wherein the actuator is configured to provide the relative translation of the first optical element at a first speed and the relative translation of the second optical element at a second speed being the first speed times a magnification factor of the apparatus.

In one embodiment, the magnification factor M of the apparatus is the ratio of the distance between the source and the second optical element to the distance between the source and the first optical element. For example, if R₁ and R₂ are the distances between the source and first optical element, and the first and second optical elements respectively, M≡(R₁+R₂)/R₁.

In a particular embodiment, the apparatus has a magnification factor of two and the actuator is configured to translate the second optical element at twice the speed as the first optical element.

Thus, when the distance from the source to the first optical element and from the first optical element to the second optical element are equal, the magnification factor of the apparatus is two and the actuator is configured to provide a translation of the second optical element that is twice as fast as that of the first optical element.

The relative translation may be effected by moving the optical elements or leaving the optical elements stationary and moving other elements of the apparatus (or some combination of these two approaches). For example, this may be done by linearly translating the first and second optical elements, or by linearly translating the object and detector.

In one embodiment, the actuator is configured to rotate the first and second optical elements about the source to effect the relative translation of the first and second optical elements. In such an embodiment, the actuator may comprise an electrically driven rotatable stage adapted to support the first and second optical elements.

In another embodiment, the actuator is configured to rotate the object and detector about the source to effect the relative translation of the first and second optical elements.

Averaging over Talbot fringes typically requires only a small translation of the optical elements (or of the object and detector) compared to their distances from the source. Linear translation of the optical elements or of the object and detector through such small distances is a good approximation to circular motion, and is sufficient in most cases.

In a preferred arrangement, however, the two optical elements—or equivalently the object and detector—are rotated about the source. The distance traveled in the rotation will, again, generally be small: the first optical element or object through a distance of the order the period of the first optical element, or an integer number of such periods to effect averaging; the second optical element or detector through a corresponding distance multiplied by the magnification of the apparatus.

In embodiments adapted for imaging large objects, the optical elements may be suitably modified, including by being curved.

The present invention has particular advantages in the simplified provision of high spatial resolution phase-contrast imaging that can use available large-area integrating detectors, such as film or photostimulable phosphor imaging plates previously regarded as inappropriate for high resolution imaging owing to their commonly poor resolution. Such detector can be employed according to the present invention if sufficient magnification is implemented. Furthermore, high spatial resolution 1-dimensional or 2-dimensional electronic detectors may be used, depending on whether 1-dimensional or 2-dimensional data is to be collected.

The present invention allows one to perform high-resolution grating-based phase contrast imaging without contamination from self-imaging (Talbot) fringes. High quality, high spatial resolution images may be collected without contamination by grating fringes, using even integrating detectors (such as film). Objects that are relatively large laterally may be imaged, by effecting the relative scanning of the gratings either by translating the gratings (if these are laterally sufficiently large) or by translating the object and detector simultaneously if the cone of illumination and/or grating lateral extent are limited.

In addition, while some known high resolution grating-based methods [18] require a high resolution detector in order to record interference patterns and the collection of several images in order to extract useful information, according to the present invention only one image need be recorded so a high speed detector readout is unnecessary.

The present invention has, in particular, clinical and biomedical applications, such as in soft tissue imaging (e.g. in mammography) and in imaging knee and other joints, and in X-ray phase-contrast computerised tomography (CT).

In a particular embodiment, the apparatus further comprises an additional optical element comprising an amplitude optical element located between the source and the first optical element in order to provide an array of small sources. This configuration can enhance image intensity from a laterally broad source relative to that for a single small source, though at the expense of the resolution depending on the total size of the source.

In a certain embodiment, the source has an effective size in the self-image plane of the first optical element (obtained by projecting the real source through a point in the first optical element to the plane of the second optical element) that is less than a quarter of a period of the self-image (typically equal to that of the first optical element or its half multiplied by the magnification factor of the apparatus).

In a particular embodiment, the detector has a resolution substantially equal to the effective size of the source in the self-image plane of the first optical element.

In one particular embodiment, the apparatus is optimised according to signal-to-noise ratio. In such embodiments, the signal-to-noise ratio may be optimised by selection of, for example, any one or more of: grating periodicity of the first diffracting optical element, grating periodicity of the second diffracting optical element and magnification.

It should be noted that apparatuses according to this aspect may form parts of instruments for 1-dimensional or 2-dimensional imaging and inspection and also of instruments for 3-dimensional imaging and reconstruction (e.g. implementing computerized tomography).

According to a second broad aspect, the present invention provides a phase-contrast imaging method for imaging an object, comprising:
irradiating the object with a radiation source;
detecting radiation from the source that has propagated through the object, a first diffracting optical element and a second diffracting optical element; and
providing a relative translation of the first and second optical elements with respect to and across a propagation direction of radiation transmitted from the source to the detector, the first optical element being translated at a first speed and the second optical element at a second speed being the first speed times a magnification factor defined by the relative positions of the source, the first optical element and the second optical element.

The magnification factor may be two and the method include translating the second optical element at twice the speed of the first optical element.

The method may comprise rotating the first and second optical elements about the source to effect the relative translation of the first and second optical elements with respect to the propagation direction.

The method may comprise rotating the object, and detector about the source to effect the relative translation of the first and second optical elements with respect to the propagation direction.

The method may comprise optimising the imaging using signal-to-noise ratio as an optimisation parameter. In such embodiments, optimising the imaging may include varying any one or more of: grating periodicity of the first diffracting optical element, grating periodicity of the second diffracting optical element and magnification.

The method may comprise performing phase or amplitude retrieval using any one or more of: a geometrical optics approximation, a weak-object approximation, a polychromatic analogue of a diffraction-enhanced image method, and a polychromatic weak-object-based method.

According to another aspect, the invention provides a method of creating a differential phase-contrast, a dark-field phase-contrast or a bright-field phase-contrast image of an object, comprising:
irradiating sequentially a first diffracting optical element and a second diffracting optical element with a radiation source;
detecting radiation that has been diffracted by the first optical element and the second optical element;
offsetting the first and second optical elements; and
providing a relative translation of the first and second optical elements with respect to and across a propagation direction of radiation transmitted from the source to the detector, the first optical element being translated at a first speed and the second optical element at a second speed being the first speed times a magnification factor defined by the relative positions of the source, the first optical element and the second optical element.

Thus, there are a number of different types of images that can be produced by changing the relative translation off-set (the Δx of the embodiments below) between the two optical elements, including bright field phase-contrast, dark-field phase-contrast and differential phase-contrast images, obtained according to the choice of this offset.

The method may include switching the orientation of the optical elements (typically for orthogonal directions) to obtain a plurality of phase-contrast images of the object.

In each of the above aspects, image data may be collected either in line scan (1-dimensional) or full-field (2-dimensional mode). One-dimensional data collection using high-speed electronic detectors can provide very fast data collection for a slice through an object. Energy analysing detectors (both 1-dimensional and 2-dimensional) can give additional information on the structure and properties of the object/sample when moderately polychromatic incident radiation is used.

According to another aspect, the invention provides a phase-contrast imaging apparatus for imaging an object, wherein the apparatus is optimised according to signal-to-noise ratio.

In one embodiment, the apparatus is optimised according to signal-to-noise-ratio with respect to a set of optimization parameters. In such embodiments, the set of optimization parameters includes a grating pitch of the first diffracting optical element, a grating pitch of the second diffracting optical element and a magnification of an image of the object.

According, to another aspect, the invention provides a phase-contrast imaging method for imaging an object, comprising optimising the imaging according to signal-to-noise ratio.

The method may comprise optimising the imaging according to signal-to-noise ratio with respect to a set of optimization parameters. The set of optimization parameters may include a grating pitch of the first diffracting optical element, a grating pitch of the second diffracting optical element and a magnification of an image of the object.

According to another aspect, the invention provides a method of deriving wave-amplitude and phase information from a plurality of diffraction images of an object collected with a scanning-grating-based imaging apparatus at different shift values, comprising employing a shift-invariant propagation function of the imaging system corresponding to the imaging apparatus and expressible in the general form:

T_{sys}(x,y,x′,y′;λ,Δx,R′)≡gᵢₙ(x′−x,y′−y,λ)P_{R′}(x,y)P*_{R′}(x′,y′)G(x−Δx,x′−Δx),
where Δx is a shift value, gᵢₙ(x′−x,y′−y, λ) is a spectral degree of coherence of radiation from a radiation source incident on a first diffracting optical element of the imaging apparatus having period d₁ and complex transmission function t₁ (x) located to receive radiation from the source, P_{R′}(x, y)≡(iλR′)⁻¹×exp [iπ(x²+y²)/(λR′)] is a paraxial approximation for a two-dimensional free-space propagator at an effective distance R′=RM⁻²(M−1) between the first optical element and a second diffracting optical element of the imaging apparatus having real-valued transmittance function T₂ located at a distance R after the first optical element, M is a magnification of the imaging apparatus, and

$$G ( x , {x}^{′} ) ≡ {d}_{1}^{- 1} {\int }_{0}^{{d}_{1}} d X {t}_{1} ( X - x ) {t}_{1}^{*} ( X - {x}^{′} ) {T}_{2} ( MX ) .$$

Thus, according to this aspect of the invention (cf. eq. (79) and associated discussion), images (or equivalently image data) can be processed to obtain information, by exploiting the shift-invariant property of the images.

The images may be collected at deflection angles that are small compared to an angular period of the propagation function.

The phase information may comprise phase-gradient information.

According to another aspect, the invention provides data processed according to this method.

According to another aspect, the invention provides a method for deriving wave-amplitude information and phase-gradient information from a plurality of diffraction images of an object collected with a scanning double-grating-based imaging apparatus, comprising:
employing a system function that corresponds to the imaging apparatus and is expressible in the general form:

r_{sys}[(Δx/R′);λ]≡\hat{T}_{sys}(0,0,0,0;λ,Δx,R′),
where Δx/R′ defines a working point on the system function and \hat{T}_{sys} is the Fourier transform of a system propagation function corresponding to the imaging apparatus and expressible in the general form:

T_{sys}(x,y,x′,y′;λ,Δx,R′)≡gᵢₙ(x′−x,y′−y,λ)P_{R′}(x,y)P*_{R′}(x′,y′)G(x−Δx,x′−Δx),
where Δx is a shift value, gᵢₙ(x′−x, y′−y, λ) is a spectral degree of coherence of radiation from a radiation source incident on a first diffracting optical element of the imaging apparatus having period d₁ and complex transmission function t₁(x) located to receive radiation from the source, P_{R′}(x, y)≡(iλR′)⁻¹×exp[iπ(x²+y²)/(λR′)] is a paraxial approximation for a two-dimensional free-space propagator at an effective distance R′=RM⁻²(M−1) between the first optical element and a second diffracting optical element of the imaging apparatus having real-valued transmittance function T₂ located at a distance R after the first optical element, M is a magnification of the imaging apparatus, and

$$G ( x , {x}^{′} ) ≡ {d}_{1}^{- 1} {\int }_{0}^{{d}_{1}} d {Xt}_{1} ( X - x ) {t}_{1}^{*} ( X - x ) {t}_{1}^{*} ( X - {x}^{′} ) {T}_{2} ( MX ) ;$$

wherein the system function is periodic with an angular period d/R′ where d is the period of the Talbot self image demagnified to a plane of the first diffracting optical element;
the images have working points that allow accurate separation of wave-amplitude and phase-derivative or related information; and

Thus, according to this aspect of the invention, it is possible to derive (simultaneously if desired) wave-amplitude information and phase-gradient information from a plurality of diffraction images (or equivalently image data). (An example is provided below in the section entitled “Diffraction-Enhanced Imaging Analogue for SDG Imaging.”)

The method may include selecting the images to have working points that allow accurate separation of wave-amplitude and phase-derivative or related information.

According to another aspect, the invention provides data processed according to this method.

According to another aspect, the invention provides an apparatus for obtaining wave-amplitude and phase information from a plurality of diffraction images of an object collected with a scanning-grating-based imaging apparatus at different shift values, the imaging apparatus having a first diffracting optical element with period d₁ and complex transmission function t₁(x) located to receive radiation from a radiation source and a second diffracting optical element with real-valued transmittance function T₂ located at a distance R after the first optical element, the apparatus comprising:
a propagation function module configured to employ a shift-invariant propagation function that corresponds to the imaging apparatus and is expressible in the general form:

T_{sys}(x,y,x′,y′;λ,Δx,R′)≡gᵢₙ(x′−x,y′−y,λ)P_{R′}(x,y)P*_{R′}(x′,y′)G(x−Δx,x′−Δx),
where Δx is a shift value, gᵢₙ(x′−x, y′−y, λ) is a spectral degree of coherence of radiation from a radiation source incident on the first diffracting optical element, P_{R′}(x,y)≡(iλR′)⁻¹ exp [iπ(x²+y²)/(λR′)] is a paraxial approximation for a two-dimensional free-space propagator at an effective distance R′=RM⁻²(M−1) between the first and second diffracting optical elements, M is a magnification of the imaging apparatus, and

$$G ( x , {x}^{′} ) ≡ {d}_{1}^{- 1} {\int }_{0}^{{d}_{1}} d {Xt}_{1} ( X - x ) {t}_{1}^{*} ( X - {x}^{′} ) {T}_{2} ( MX ) .$$

This apparatus may comprise a computer executing computer readable code, or a computer readable medium with such code. In another aspect, the invention provides data processed with this apparatus.

According to another aspect, the invention provides an apparatus for obtaining wave-amplitude information and phase-gradient information from a plurality of diffraction images of an object that have working points that allow accurate separation of wave-amplitude and phase-derivative or related information, the images having been collected with a scanning double-grating-based imaging apparatus having a first diffracting optical element with period d₁ and complex transmission function t₁(x) located to receive radiation from a radiation source and a second diffracting optical element with real-valued transmittance function T₂ located at a distance R after the first optical element, the apparatus comprising:
a system function module configured to employ a system function that corresponds to the imaging apparatus and is expressible in the general form:

r_{sys}[(Δx/R′);λ]≡\hat{T}_{sys}(0,0,0,0;λ,Δx,R′),
where Δx/R′ defines a working point on the system function and \hat{T}_{sys} is the Fourier transform of a shift-invariant system propagation function corresponding to the imaging apparatus; and
a propagation function module configured to employ the system propagation function, the system propagation function being expressible in the general form:

T_{sys}(x,y,x′,y′;λ,Δx,R′)≡gᵢₙ(x′−x,y′−y,λ)P_{R′}(x,y)P*_{R′}(x′,y′)G(x−Δx,x′−Δx),
where Δx is a shift value, gᵢₙ(x′−x, y′−y, λ) is a spectral degree of coherence of radiation from a radiation source incident on a first diffracting optical element of the imaging apparatus, P_{R′}(x, y)≡(iλR′)⁻¹×exp[iπ(x²+y²)/(λR′)] is a paraxial approximation for a two-dimensional free-space propagator at an effective distance R′=RM⁻²(M−1) between the first optical element and a second diffracting optical element of the imaging apparatus, M is a magnification of the imaging apparatus, and

$$G ( x , {x}^{′} ) ≡ {d}_{1}^{- 1} {\int }_{0}^{{d}_{1}} d {Xt}_{1} ( X - x ) {t}_{1}^{*} ( X - {x}^{′} ) {T}_{2} ( MX ) ;$$

wherein the system function is periodic with an angular period d/R′ where d is the period of the Talbot self image demagnified to a plane of the first diffracting optical element.

It should be understood that the optional features of any aspect of the invention may be employed, where suitable, with any other aspect of the invention.

### BRIEF DESCRIPTION OF THE DRAWINGS

In order that the invention may be more clearly ascertained, embodiments will now be described, by way of example, with reference to the accompanying drawing, in which:

FIG. 1A is a schematic elevational view of a scanning double-grating imaging apparatus according to an embodiment of the present invention, with an object comprising a sphere;

FIG. 1B is a simplified perspective view of the apparatus of FIG. 1A, with an object comprising a sphere;

FIG. 1C is a simplified plan view of the apparatus of FIG. 1A, with an object comprising a sphere and illustrating the Δx=0 condition of maximum grating alignment;

FIG. 2A is another simplified plan view of the apparatus of FIG. 1A, illustrating the relative motion of the first and second gratings in use;

FIG. 2B is simplified plan view of a scanning double-grating imaging apparatus 32 according to an alternative embodiment of the present invention;

FIG. 3 is a simplified plan view of a scanning imaging apparatus according to another embodiment of the present invention, with an object comprising a sphere and illustrating the Δx=0 condition of maximum grating alignment;

FIG. 4A is the calculated projected phase immediately in front of the first (phase) grating of the apparatus of FIG. 1A of an object comprising a sphere of diameter 250 μm;

FIG. 4B is the calculated phase of the wave immediately after the first grating of the apparatus of FIG. 1A, for a grating period d=8 μm and X-ray energy 20 keV, producing n/2 phase modulation;

FIGS. 4C and 4D are simulated images calculated as a comparative example for an ideal detector and a finite-resolution detector (with a point-spread function of 20 μm FWHM) respectively assuming incident plane wave (M=1), for the zero relative grating position configuration (Δx=0) shown in FIG. 1C;

FIGS. 4E and 4F are simulated images calculated as a comparative example for ideal and finite-resolution detectors respectively, for Δx=d/4 (d being the period of the Talbot self-mage created by the first grating and equal in this configuration to the period of the first and second gratings);

FIGS. 5A and 5B are simulated images calculated as a comparative example for ideal and finite-resolution detectors respectively, for Δx=2d/4;

FIGS. 5C and 5D are simulated images calculated as a comparative example for ideal and finite-resolution detectors respectively, for Δx=3d/4;

FIG. 5E is the sum of the images of FIGS. 4C, 4E, 5A and 5C, corresponding to the four values of Δx=0, d/4, 2d/4 and 3d/4, for an ideal detector;

FIG. 5F is the sum of the images of FIGS. 4D, 4F, 5B and 5D, corresponding to the four values of Δx=0, d/4, 2d/4 and 3d/4, for a finite-resolution detector;

FIGS. 6A to 6D are simulated images of a sphere of diameter 250 μm, calculated according to the embodiment of FIG. 1A and for different positions of the gratings of the apparatus of FIG. 1A, for a relative grating position of Δx=0 and respective grating positions of x₁=0, x₂=0; x₁=d/4, x₂=d/4; x₁=2d/4, x₂=2d/4; and x₁=3d/4, x₂=3d/4;

FIG. 6E is a simulated bright-field image, comprising the sum of the four Δx=0 images of FIGS. 6A to 6D;

FIGS. 7A to 7D are simulated images of a sphere of diameter 250 μm, calculated according to the embodiment of FIG. 1A and for different positions of the gratings of the apparatus of FIG. 1A, for a relative grating position of Δx=d/4 and respective grating positions of x₁=0, x₂=d/4; x₁=d/4, x₂=2d/4; x₁=2d/4, x₂=3d/4; and x₁=3d/4, x₂=0;

FIG. 7E is a simulated differential-contrast image, comprising the sum of the four Δx=d/4 images of FIGS. 7A to 7D;

FIGS. 8A to 8D are simulated images of a sphere of diameter 250 μm, calculated according to the embodiment of FIG. 1A and for different positions of the gratings of the apparatus of FIG. 1A, for a relative grating position of Δx=2d/4 and respective grating positions of x₁=0, x₂=2d/4; x₁=d/4, x₂=3d/4; x₁=2d/4, x₂=0; and x₁=3d/4, x₂=d/4;

FIG. 8E is a simulated dark-field image, comprising the sum of the four Δx=2d/4 images of FIGS. 8A to 8D;

FIGS. 9A to 9D are simulated images of a sphere of diameter 250 μm, calculated according to the embodiment of FIG. 1A and for different positions of the gratings of the apparatus of FIG. 1A, for a relative grating position of Δx=3d/4 and respective grating positions of x₁=0, x₂=3d/4; x₁=d/4, x₂=0; x₁=2d/4, x₂=d/4; and x₁=3d/4, x₂=2d/4;

FIG. 9E is a simulated differential-contrast image, comprising the sum of the four Δx=3d/4 images of FIGS. 9A to 9D;

FIG. 10 is a simulated image, comprising the sum of the images of FIGS. 6E, 7E, 8E and 9E;

FIGS. 11A to 11D are simulated images of a sphere of diameter 250 μm and another background art grating-based phase-contrast imaging technique (involving a single grating), as a further comparative example, for respective grating positions of x₁=0, x₁=d/4, x₁=2d/4 and x₁=3d/4;

FIG. 11E is the sum of the images of FIGS. 11A to 11D;

FIG. 11F comprises the result of processing any of the images of FIGS. 11A to 11D, by convolving with a Gaussian function with 20 μm FWHM;

FIG. 12A is the result of processing the four images of FIGS. 11A to 11D according to equation (9) of reference [18];

FIG. 12B is the result of smearing of the image of FIG. 12A with a Gaussian function with 4 μm FWHM;

FIGS. 13A to 13D are simulated images of a sphere of diameter 250 μm and the apparatus of FIG. 1A, with a finite source size w_{S} (comprising an effective source in the self-image plane modelled using a Gaussian function with 4 μm FWHM) and respective relative grating positions of Δx=0, Δx d/4, Δx=2d/4 and Δx=3d/4;

FIG. 13E is a calculated image of the sphere simulated in FIGS. 13A to 13D, comprising the sum of the four images of FIGS. 13A to 13D;

FIGS. 14A to 14D are simulated differential-contrast images of a sphere of diameter 0.5 mm smeared with a 100 μm (FWHM) Gaussian function, calculated according to the embodiment of FIG. 1A and with Δx=d/4, with the geometrical parameters of Table 1, λ=3 Å, d₂=48 μm, λ=3 Å, d₂=24 μm, λ=3 Å, d₂=12 μm, and λ=1.5 Å, d₂=12 μm respectively, a finite source, w_{S}=d/8, and an ideal detector;

FIGS. 15A and 15B are simulated differential-contrast images of a sphere of diameter 0.5 mm smeared with a 100 μm (FWHM) Gaussian function, calculated according to the embodiment of FIG. 1A and with Δx=d/4, with the geometrical parameters of Table 2 corresponding to w_{S}=5 μm, d₂=8 μm and λ=1 Å and 0.5 Å respectively;

FIG. 16A comprises plots of model spectral distributions as functions of X-ray energy (Gaussians with different FWHM being used for λ);

FIG. 16B comprises plots of simulated ‘reflectivity’ curves (in the differential contrast regime with Δx=d/4) corresponding to monochromatic radiation with λ=3 Å and using the spectral distributions shown in FIG. 16A;

FIG. 16C comprises plots of the first derivative of the simulated reflectivity curves shown in FIG. 16B;

FIG. 16D comprises plots of the second derivative of the simulated reflectivity curves shown in FIG. 16B;

FIGS. 17A to 17D are dark-field images of a sphere of diameter 0.5 mm smeared with a 100 μm (FWHM) Gaussian function, using a (central) X-ray wavelength λ=3 Å, with the FWHM of the Gaussian spectral distribution of the source being, respectively, 0, 10%, 20% and 80%;

FIG. 18 comprises plots of system function versus “deviation angle” for different values of the ratio w_{Src,eff}/d, w_{Src,eff} being the effective width of the Gaussian source in the self-image plane and d the period of the self-image;

FIG. 19 is comparable to FIG. 18, but compares the influence of Gaussian and rectangular sources with the same width on the system function;

FIG. 20 is a plot of the system function, corresponding to the Gaussian source characterised by the parameter w_{Src,eff}/d=0.3, showing that it can be well approximated by a sine function (a single term in its Fourier series);

FIG. 21 is a plot of the system function, corresponding to the rectangular (uniform) source characterised by the parameter A_{src,eff}/d=0.33, showing that it can be well approximated by a sine function (a single term in its Fourier series);

FIG. 22 comprises plots of the ratio Θ|r′_{sys}|r_{sys}^{-1/2} as a function of on θ/Θ for different values of w_{Src,eff}/d (Gaussian source);

FIG. 23 shows the dependence of the damping function D (see eq. (74)) on system magnification M for different values of the width, w_{Src}, of the Gaussian source;

FIG. 24 shows the optimum magnification, Mₒₚₜ, versus the dimensionless parameters p_{det}=σ_{det}/σ_{obj} and q_{src}=w_{Src}(λR)^{1/2};

FIG. 25 shows the maximum value of the damping function, Dₘₐₓ, versus the dimensionless parameters p_{det}=σ_{det}/σ_{obj} and q_{src}=w_{Src}/(λR)^{1/2}; and

FIG. 26 shows the dependence of the damping function (see eq. (74)) on system magnification for different values of the width, A_{src}, of a uniform (rectangular) source.

### DETAILED DESCRIPTION

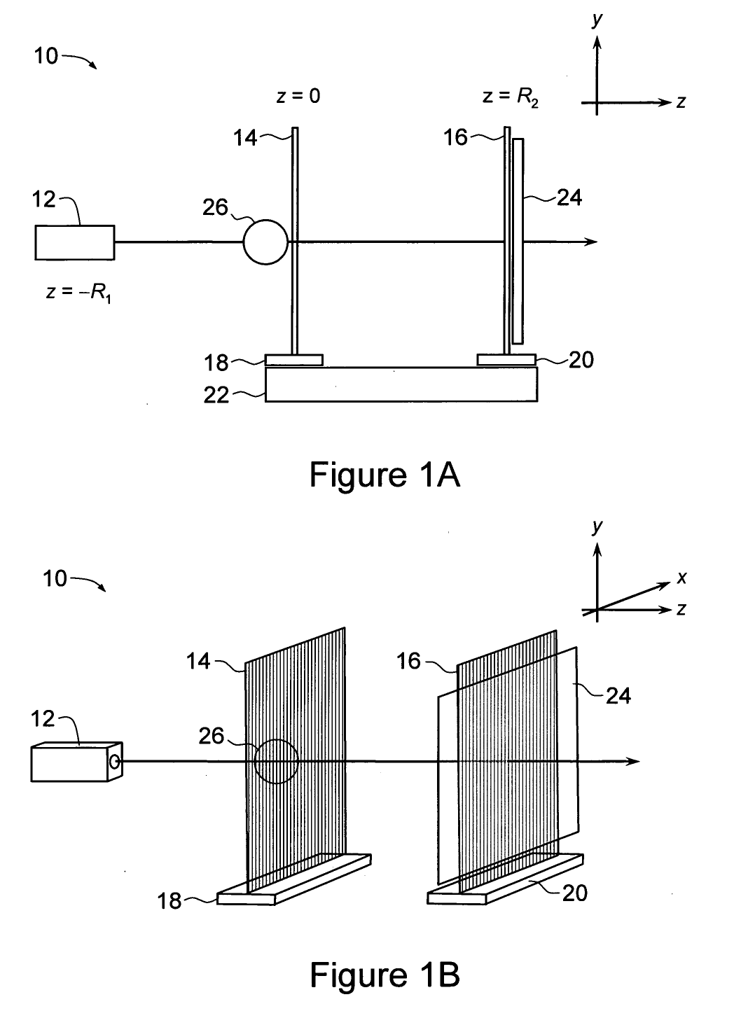

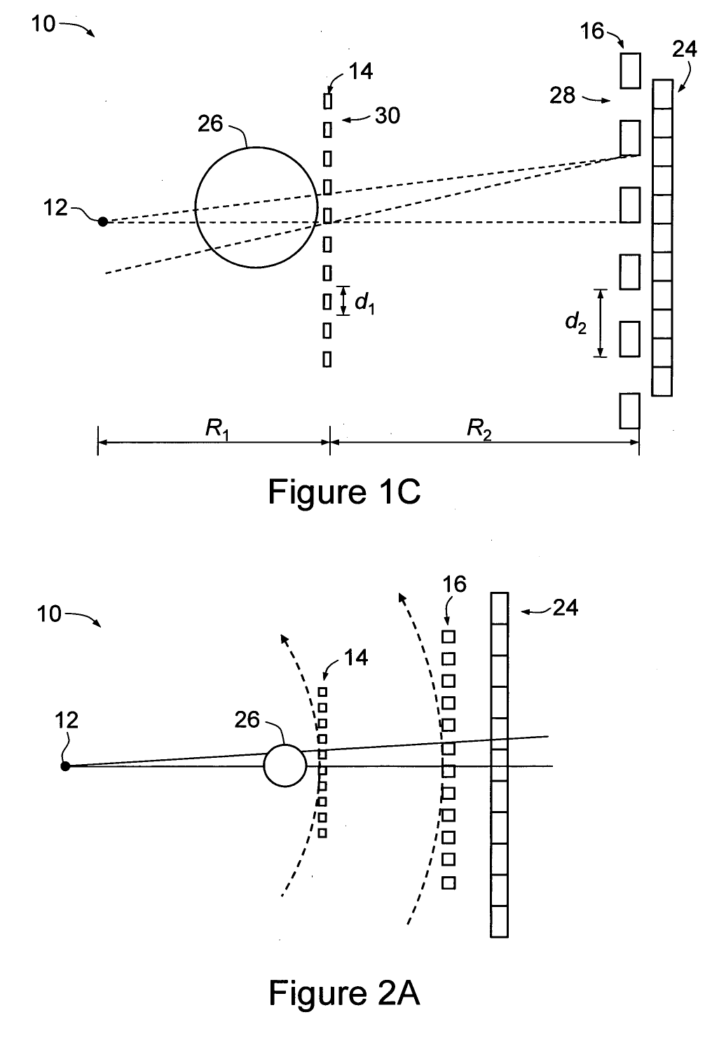

FIG. 1A is a schematic elevational view—and FIG. 1B a corresponding, simplified perspective view—of a scanning double-grating imaging apparatus 10 according to an embodiment of the present invention, shown with an object to be imaged in the form of a sphere. Apparatus 10 comprises a radiation source 12, a pair of optical elements in the form of a first diffraction grating 14 and a second diffraction grating 16, and respective bases 18, for supporting first and second gratings 14, 16. First grating 14 is located between source 12 and second grating 16. First and second gratings 14, 16 are illustrated with their slits or rulings extending in the y direction.

In this embodiment, source 12 is a source of penetrating radiation in the form of X-rays, which are emitted by source 12 along the z-axis, but in other embodiments imaging may be conducted with other forms of penetrating radiation, such as visible light (i.e. when the imaged object is transparent), gamma-rays, neutrons or other forms of particles and waves.

First grating 14 comprises a phase (or in other embodiments, amplitude) grating, while second grating 16 comprises an amplitude grating. Again, it will be appreciated by those in the art that other combinations are possible.

Apparatus 10 also includes an actuator in the form of a rotatably mounted, electrically driven stage 22 for rotating first and second gratings 14, 16 about source 12 and hence translating first and second gratings 14, 16 in the positive or negative x direction across the direction of radiation propagation from source 12 during image collection, and a detector 24 (in this embodiment, X-ray sensitive film) immediately behind (i.e. relative to source 12) second grating 16. Object 26 (in this example, a sphere) is depicted adjacent first grating 14, on the side of source 12. Apparatus 10 also includes a sample stage (not shown) for supporting object 26.

FIG. 1C is a simplified plan view of apparatus 10, again with object 26, illustrating the Δx=0 condition of maximum grating alignment, where the relative position of the gratings, Δx, is defined in terms of the positions x₁ and x₂ of first and second gratings 14, 16 respectively as Δx=(x₂/M)−x₁. In this condition, the period of the second grating 16 is equal to that of the first grating 14 (or, in some embodiments, to a half-period of first grating 14) multiplied by the magnification M of apparatus 10 with, for example, the slits 28 of second grating 16 aligned with the slits 30 of first grating 14 from the perspective of source 12. It is the relative position Δx of gratings 14, 16 that defines the type of the image produced by the apparatus including bright-field, dark-field and differential-contrast images. The parameter Δx may be defined in various ways, so the relationship between Δx and the type of image depends on the structure of the optical elements and the particular definition adopted for Δx.

Stage 22 is configured to rotate first and second gratings 14, 16 during image collection at the same, constant angular speed. Stage 22 thereby translates first and second gratings 14, 16 with the same angular speed (and hence with different lateral speeds that are a function of their distance from the centre of rotation, viz. source 12) from the perspective of source 12, as the respective instantaneous linear speeds of the gratings depend on the geometry of apparatus 10. Second grating 16 is translated at a speed equal to that of the translation of first grating 14 multiplied by the magnification of apparatus 10.

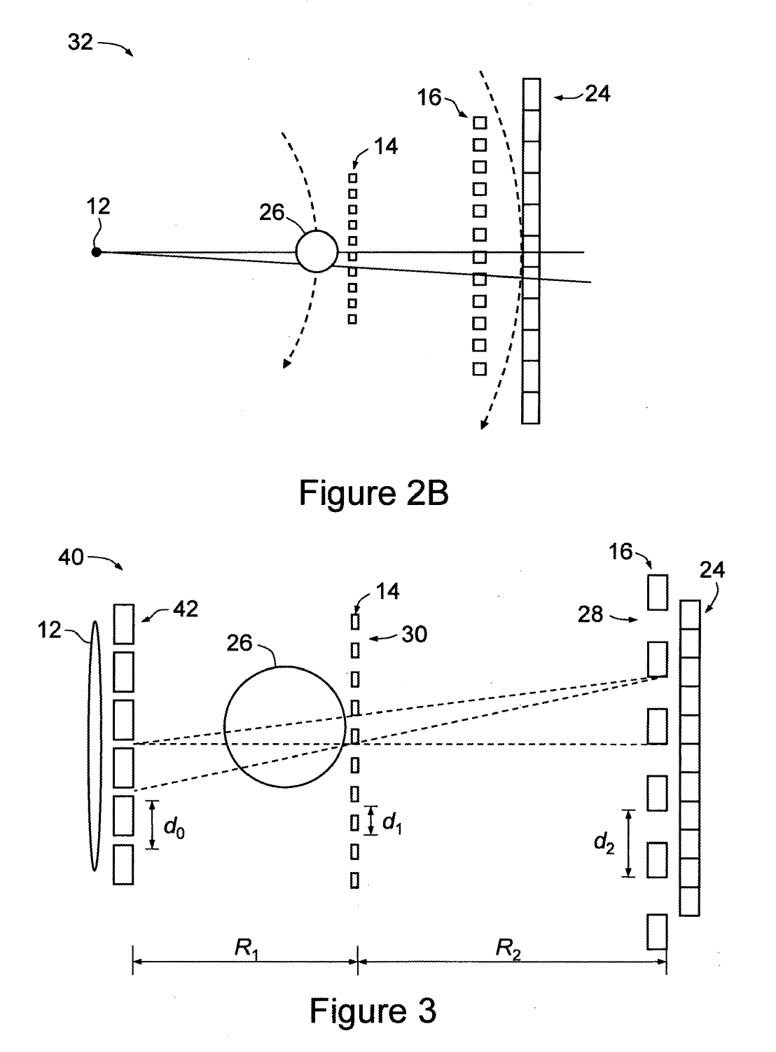

FIG. 2A is another simplified plan view of apparatus 10, illustrating the relative translation of first and second gratings 14, 16 with respect to the propagation direction of radiation from source 12 to detector 24, in use. Stage 22 (not shown in this figure) is configured to rotate first and second gratings 14, 16 about source 12 to effect the relative translation of first and second gratings 14, 16. In the collection of an image, averaging over Talbot fringes typically requires translation of the second grating 16 over one its period (or integer number of its periods) while the first grating 14 is translated over a distance that is equal to the translation distance of the second grating 16 divided by the magnification factor of the apparatus. The gratings' translations are small; translation through around 100 periods, for example, involves translation of second grating 16 by about 1 mm.

In the illustrated geometry, for example, first grating 14 is R₁ from source 12 and second grating 16 is R₂ from first grating 14. If R₁=R₂ (i.e. the magnification factor is two), stage 22 rotates and hence translates second grating 16 at twice the speed that it translates first grating 14 (and in the same direction). However, if second grating 16 were moved to z=2R₁, the magnification factor would become three, and stage 22 would translate second grating 16 at three times the speed that it would translate first grating 14 (though again in the same direction).

It will be appreciated by those in the art that the effect of rotating first and second gratings 14, 16 about source 12 may equivalently be obtained by rotating object 26 and detector 24 about source 12, while keeping first and second gratings 14, 16 stationery. In such an embodiment, the relative translation of first and second gratings 14, 16 relative to the propagation direction of radiation from source 12 to detector 24 is effected by this rotation of object 26 and detector 24. This is done with an alternative actuator (not shown), comprising a driven stage that supports and rotates object 26 and detector 24 (much as stage 22 supports and rotates first and second gratings 14, 16 in apparatus 10). FIG. 2B is simplified plan view of a scanning double-grating imaging apparatus 32 according to such an alternative embodiment of the invention, illustrating this alternative arrangement and method of providing the relative translation of first and second gratings 14, 16.

Apparatus 10 is sufficiently mechanical stable and rigid that the relative positions of first and second gratings 14, 16 are preserved during their rotation—from the perspective of source 12—to significantly less than a Talbot self-image period.

The translation of gratings 14, 16 during image collection improves resolution, contrast (if used with a high resolution detector) and signal-to-noise ratio compared with double-grating imaging apparatuses of the background art. Moreover, unlike single-grating imaging apparatuses of the background art, the approach of this embodiment does not require the acquisition of multiple images or their further numerical processing, so even high resolution X-ray film can be used as the detection medium.

A rigorous wave-optical formalism can be derived as follows for image formation in the case of an arbitrary scanning double-screen imaging system, such as apparatus 10, assuming monochromatic plane incident wave.

Both optical elements (e.g. gratings 14 and 16 of FIGS. 1A and 1B) may be characterized by their complex transmission functions, t₁(x) and t₂(x), which are assumed to depend only on the x-coordinate. The following analysis is restricted to the case where the first optical element (e.g. grating 14) is located immediately after an object (e.g. sphere 26), in the exit plane of the object (the object plane, for brevity), and the distance between the second optical element (e.g. grating 16) and the detector (e.g. detector 24) is negligibly small. Designating q(x, y) the complex transmission function of the object and assuming that a monochromatic plane wave (thus R₁>>R₂) of unit intensity and wavelength λ is incident onto the object, the complex amplitude of the wave immediately after the first optical element (“OE1”) is written:

E_{OE1}(x,y;x₀)=q(x,y)t₁(x−x₁), (1)

where x₁ is a position of the first optical element along the x-axis. The corresponding wave amplitude in the detector plane is then

E_{det}(x,y;x₁,Δx)=(E_{OE1}*P_{R}_{₂})(x,y;x₁)t₂(x−x₁−Δx), (2)

where x₂≡x₁+Δx is a position of the second optical element (“OE2”) along the x-axis with the second optical element shifted a distance Δx with respect to the first, P_{z}(x,y)=P_{z}(x)P_{z}(y)≡(iλz)⁻¹ exp[iπ(x²+y²)/(λz)] is a paraxial approximation for the two-dimensional (2D) free-space propagator at a distance z, and the asterisk “*” between two functions denotes convolution of the functions. The intensity in the detector plane at the fixed positions x₁ and x₁+Δx of the first and the second optical elements is written:

I_{det}(x,y;x₁,Δx)=|(E_{OE1}*P_{R}_{₂})(x,y;x₁)|²T₂(x−x₁−Δx), (3)

where T₂(x)≡|t₂(x)|² is a transmittance function of the second optical element.

A scenario is considered in which both optical elements are scanned together (keeping the transversal shift Δx constant) along the x-axis while the image is collected. If both optical elements are periodic (e.g. gratings), with period d, then scanning at an integral number (one or more) periods is performed. In the case of non-periodic optical elements (e.g. slits), scanning of the optical elements across the whole horizontal field of view [−A, A] is performed. Mathematically, such scanning results in the integration of the intensity I_{D}(x, y; x₁, Δx) over in the interval L, equal to correspondingly [0, d] and [−A, A] in the periodic and non-periodic case. Hence,

I_{det}(x,y;Δx)≡|L|⁻¹∫_{L}dx₁I_{det}(x,y;x₁,Δx), (4)

where |L| is the length of the interval L. Substituting equation (3) into equation (4) one obtains:

I_{det}(x,y;Δx)=∫∫dx′dx″q_{R}_{₂}(x−x′,y)q*_{R}_{₂}(x−x″,y)Tₓ(x′,x″;Δx), (5)

where

q_{R}_{₂}(x,y)≡∫dy′q(x,y−y′)P_{R}_{₂}(y′), (6)

is a result of applying the y-component of the free-space propagator to the object wave,

Tₓ(x′,x″;Δx)≡P_{R}_{₂}(x′)P*_{R}_{₂}(x″)G(x′−Δx,x″−Δx), (7)

is a newly introduced propagation function of the imaging system along the x-axis, and the function G(x′, x″) is defined as

G(x′,x″)≡|L|⁻¹∫_{L}dx₁t₁(x₁−x′)t*₁(x₁−x″)T₂(x₁). (8)

The Fourier transform of the image intensity distribution over the coordinate x—indicated by superscript (1)—is:

Î_{det}⁽¹⁾(u,y;Δx)=∫du′\hat{q}_{R}_{₂}⁽¹⁾(u+u′,y)[\hat{q}_{R}_{₂}⁽¹⁾(u′,y)]*\hat{T}ₓ(u+u′,−u′;Δx), (9)

where the transfer function \hat{T}ₓ(u,u′; Δx) of the imaging system along the x-axis (i.e. the Fourier transform of the propagation function of the imaging system) can be presented as:

\hat{T}ₓ(u,u′;Δx)=∫∫dwdw′\hat{P}_{R}_{₂}(u−w)\hat{P}*_{R}_{₂}(u′−w′)Ĝ(w,w′)exp[2πi(w+w′)Δx]. (10)

Taking the explicit form of the free-space propagators into account, one may obtain an equivalent form for the transfer function:

\hat{T}ₓ(u,u′;Δx)=\hat{P}_{R}_{₂}(u)\hat{P}*_{R}_{₂}(u′)∫∫dwdw′\hat{P}_{R}_{₂}(w)\hat{P}*_{R}_{₂}(w′)Ĝ(w,w′)×exp{2πi[w(Δx+λR₂u)+w′(Δx−λR₂u′)]}. (11)

The above formalism can be generalised to the case of a partially coherent incident wavefield. Using the approach of [24], the cross-spectral density [25] of the incident beam may be represented as:

\tilde{Π}ᵢₙ(x,y,x′,y′,λ)=Wᵢₙ(x,y,x′,y′,λ)exp[iπ(x²+y²−x′²−y′²)/(λR₁)], (12)

where (x, y) and (x′, y′) are the Cartesian coordinates of two arbitrary points in the object plane, R₁ is the distance from the source to the object. Taking into account transmission through the object and the first grating, propagation from the first to the second grating and transmission through the second grating, the spectral density in the detector plane, located immediately after the second grating, can be expressed as:

S_{det}(x,y,λ;x₁,x₂)=T₂(x−x₂)∫∫∫∫dXdX′dYdY′Wᵢₙ(X,Y,X′,Y′,λ)(λR₁)²P_{R}_{₁}(X,Y)P*_{R1}(X′,Y′)×q(X,Y)q*(X′,Y′)t₁(X−x₁)t*₁(X′−x₁)×P_{R}_{₂}(x−X,y−Y)P*_{R}_{₂}(x−X′,y−Y′), (13)

where x_{1,2} is the position along the x-axis of the first and second grating respectively. Equation (13) can be transformed to the equivalent form:

M²S_{det}(Mx,My,λ;x₁,x₂)=T₂(Mx−x₂)∫∫∫∫dXdX′dYdY′Wᵢₙ(X,Y,X′,Y′,λ)q(X,Y)q*(X′,Y′)×t₁(X−x₁)t*₁(X′−x₁)P_{R′}(x−X,y−Y)P*_{R′}(x−X′,y−Y′), (14)

where M=(R₁+R₂)/R₁ is the geometrical magnification of the imaging system and R′≡R₁R₂/(R₁+R₂) is the effective object-to-detector distance.

Following reference [24], one may consider a model for partially coherent incident illumination which represents a generalization of the Schell model (for which the spatial coherence properties in the plane of incidence depend only on the distance between the points in this plane). According to this model the function Wᵢₙ in the incident cross-spectral density has the following form,

Wᵢₙ(x,y,x′,y′,λ)=Sᵢₙ^{1/2}(x,y,λ)Sᵢₙ^{1/2}(x′,y′,λ)gᵢₙ(x−x′,y−y′,λ)×exp{i[φᵢₙ(x,y,λ)−φᵢₙ(x′,y′,λ)]}, (15)

where Sᵢₙ is the spectral density of the incident wave and we allowed for an additional phase term φᵢₙ in the incident wave (apart from the explicit parabolic term).

Substituting equation (15) into equation (14), one obtains:

M²S_{det}(Mx,My,λ;x₁,x₂)=T₂(Mx−x₂)∫∫∫∫dXdX′dYdY′gᵢₙ(X′−X,Y′−Y,λ)Q(x−X,y−Y)×Q*(x−x′,y−Y′)t₁(x−X−x₁)t*₁(x−X′−x₁)P_{R′}(X,Y)P*_{R′}(X′,Y′), (16)

where a modified transmission function Q=Sᵢₙ^{1/2}exp(iφᵢₙ)q has been introduced. Assuming that x₂=Mx₁+M Δx and integrating equation (16) over x₁ (thus the second optical element is shifted M times faster than the first), the spectral density in the detector plane is obtained,

M²S_{det}(Mx,My,λ;Δx)=∫∫∫∫dXdX′dYdY′T_{sys}(X,Y,X′,Y′;λ,Δx)Q(x−x,y−Y)×Q*(x−x′,y−Y′), (17)

where the propagation function of the system has been introduced:

T_{sys}(x,y,x′,y′;λ,Δx)≡gᵢₙ(x′−x,y′−y,λ)P_{R′}(x,y)P*_{R′}(x′,y′)G(x−Δx,x′−Δx), (18)

and by analogy with the case of an incident plane wave, the function G(x, x′) is defined as

G(x,x′)≡|L|⁻¹∫_{L}dx₁t₁(x₁−x)t*₁(x₁−x′)T₂(Mx₁), (19)

where the integration interval L is as defined above.

Applying the Fourier transform to equation (17), one obtains the following general expression:

Ŝ_{det}(u/M,v/M,λ;Δx)=∫∫dUdV\hat{T}_{sys}(u+U,v+V,−U,−V;λ,Δx)\hat{Q}(u+U,v+v)\hat{Q}*(U,V). (20)

The transfer function of the imaging system, \hat{T}_{sys}(u,v,u′,v′; λ, Δx), corresponds to partially coherent incident illumination characterized by the spectral degree of coherence gᵢₙ(x′−x,y′−y, λ) that, according to the generalized Schell model used herein, depends only on the distance between two arbitrary points (x, y) and (x′, y′) in the plane of incidence. This “partially coherent” transfer function can be expressed via the “ideal” transfer function, \hat{T}_{id}(u, v, u′, v′; λ, Δx), which corresponds to coherent incident illumination with gᵢₙ≡1, as:

\hat{T}_{sys}(u,v,u′,v′;λ,Δx)=∫∫dUdVĝᵢₙ(U,V,λ)\hat{T}_{id}(u+U,v+V,u′−U,v′−V;λ,Δx). (21)

One practically important case is an extended spatially incoherent source [25], characterized by a normalized spectral density distribution in the source plane, S_{src}(x, y, λ). It results in the Schell-type incident illumination characterized by a uniform spectral density function, Sᵢₙ=Sᵢₙ(λ), and by a spectral degree of coherence related to the spectral density distribution in the source plane via a rescaled Fourier transform,

gᵢₙ(Δx,Δy,λ)=Ŝ_{src}[−Δx/(λR₁),−Δy/(λR₁),λ]. (22)

Equation (17) can be equivalently presented as follows,

M²S_{det}(Mx,My,λ;Δx)=∫∫dXdX′∫∫dYdY′Q(X,Y)Q*(X′,Y′)×∫∫dUdU′exp{−2πi[U(x−X)+U′(x−X′)]}×∫∫dVdV′exp{−2πi[V(y−Y)+V′(y−Y′)]}×\hat{T}_{sys}(U,V,U′,V′;λ,Δx). (23)

If it is assumed that the object transmission function Q is slow varying compared to the system transmission function T_{sys} then, applying the stationary-phase method [23] to the eight-fold integral in equation (23) and preserving only the first term in the corresponding decomposition formula (thus neglecting the in-line contrast and the diffraction effects due to the intensity variations in the object wave), one obtains the geometrical optics approximation for the spectral density in the detector plane:

M²S_{det}(Mx,My,λ;Δx)≅S₀(x,y,λ)\hat{T}_{sys}(u₀,u₀,−u₀,−u₀;λ,Δx), (24)

where S₀≡|Q|², φ≡arg(Q) and u₀≡−(2π)⁻¹∂ₓφ(x, y). It may be noted that a similar result has been obtained for the analyser-based imaging system [26].

According to equations (11) and (21), the system transfer function in equation (24) can be presented alternatively in the following form:

\hat{T}_{sys}(u₀,u₀,−u₀,−u₀;λ,Δx)≡r_{sys}[(Δx/R′)+λu₀], (25)

where r_{sys}(θ)≡∫∫dUdV ĝᵢₙ(U, V, λ) r_{id}(θ+λU) and r_{id} (θ)≡\hat{T}_{id}(0,0,0,0; λ, R′θ). The newly introduced functions r_{sys}(θ) and r_{id}(θ), where θ is a deflection angle of the x ray due to the object, are analogous to correspondingly the rocking curve and the intrinsic reflectivity curve of the analyser crystal in analyser-based imaging [26].

Given the spectral density in the detector plane, S_{det}(x,y,λ;Δx), the corresponding intensity distribution I_{det}(x,y;Δx) in the detector plane is:

I_{det}(x,y;Δx)=∫dλS_{det}(x,y,λ;Δx).

Formation of the quasi-monochromatic image according to the present embodiment is described by a formalism that is mathematically identical to that obtained in the case of a polychromatic analyser-based imaging [26]. Therefore the object wave phase/amplitude reconstruction algorithms [26] developed for the analyser-based imaging (using either the weak-object approximation or the geometrical optics approximation) can be applied to the imaging method of this embodiment, though with a different definition for the transfer function of apparatus 10.

The general results of equations (17) to (21) may be applied to a scanning-based imaging system comprising two gratings according to the present invention. If d is a period of the first grating and Md the corresponding period of the second grating then the transmission function t₁(x) of the first grating and the transmittance function T₂(x) of the second grating may be conveniently represented in the form of Fourier series thus:

$${t}_{1} ( x ) = {\sum }_{n} {a}_{n} exp ( - 2 π i nx / d ) , \\ {T}_{2} ( x ) = {\sum }_{n} {b}_{n} exp ⌊ - 2 π i nx ( Md ) ⌋ , \qquad ( 26 )$$

where the Fourier coefficients are defined in general as

$${a}_{n} = {d}^{- 1} {\int }_{0}^{d} d x exp ( 2 π i nx / d ) {t}_{1} ( x ) , \\ and \\ \begin{matrix}{b}_{n} = {( Md )}^{- 1} {\int }_{0}^{Md} d x exp [ 2 π i nx / ( Md ) ] {T}_{2} ( x ) \\ = {d}^{- 1} {\int }_{0}^{d} d x exp ( 2 π i nx / d ) {T}_{2} ( M x ) .\end{matrix} \qquad ( 27 )$$

Substituting equation (26) into equation (19) with L=[0, d], one obtains,

$$G ( x , {x}^{′} ) = {\sum }_{n} {\sum }_{m} {a}_{n} {a}_{m}^{*} {b}_{m - n} exp [ 2 π i ( nx - {mx}^{′} ) / d ] . \qquad ( 28 )$$

The “ideal” transfer function of a double-grating imaging system according to the present invention (with a coherent incident illumination) is then obtained by taking the Fourier transform of equation (18) with gᵢₙ=1,

$${\hat{T}}_{id} ( u , v , {u}^{′} , {v}^{′} ; λ , Δ x ) = {\sum }_{n} {\sum }_{m} {a}_{n} {a}_{m}^{*} {b}_{m - n} exp [ 2 π i ( m - n ) Δ x / d ] {\hat{P}}_{{R}^{′}} ( u + n / d , v ) \times {\hat{P}}_{{R}^{′}}^{*} ( {u}^{′} - m / d , {v}^{′} ) . \qquad ( 29 )$$

Substituting equation (29) into equation (21), one obtains

$${\hat{T}}_{sys} ( u , v , {u}^{′} , {v}^{′} ; λ , Δ x ) = {\sum }_{n} {\sum }_{m} {a}_{n} {a}_{m}^{*} {b}_{m - n} exp [ 2 π i ( m - n ) Δ x / d ] {\hat{P}}_{{R}^{′}} ( u + \frac{n}{d} , v ) \times {\hat{P}}_{{R}^{′}}^{*} ( {u}^{′} - \frac{m}{d} , {v}^{′} ) {g}_{i n} [ {λ}_{{R}^{′}} ( u + \frac{n}{d} + {u}^{′} - \frac{m}{d} ) , {λ}_{{R}^{′}} ( v + {v}^{′} ) , λ ] . \qquad ( 30 )$$

A comparison of equations (29) and (30) shows that the effect of partial coherence in the incident generalized Schell-model illumination results in the appearance of the damping factor in equation (30); this is merely a rescaled spectral degree of coherence.

Calculation of the grating-based images is significantly simplified if the spectral degree of coherence allows factorization with respect to Δx and Δy, that is,

gᵢₙ(Δx,Δy,λ)=g_{in,x}(Δx,λ)g_{in,y}(Δy,λ).

Equation (20) can then be simplified to:

$${\hat{S}}_{det} ( \frac{u}{M} , \frac{v}{m} , λ ; Δ x ) = {g}_{i n , y} ( λ {R}^{′} v , λ ) {\hat{S}}_{⊥} ( u , v , λ ; Δ x ) , \qquad ( 31 )$$

where Ŝ_{⊥}(u, v, λ; Δx) and \hat{T}ₓ(u, u′; λ, Δx) are defined as:

$$\begin{matrix}{\hat{S}}_{⊥}^{( 1 )} ( u , y , λ ; Δ x ) ≡ \int d U {{\hat{Q}}_{{R}^{′}}^{( 1 )} ( u + U , y ) [ {\hat{Q}}_{{R}^{′}}^{( 1 )} ( U , y ) ]}^{*} {\hat{T}}_{x } ( u + U , - U ; λ , Δ x ) , \\ and {\hat{T}}_{x} ( u , {u}^{′} ; λ , Δ x ) & ( 32 ) \\ = {\sum }_{n} {\sum }_{m} {a}_{n} {a}_{m}^{*} {b}_{m - n} exp [ 2 π i ( m - n ) Δ x / d ] {\hat{P}}_{{R}^{′}} ( u + n / d ) \times {P}_{{R}^{′}}^{*} ( {u}^{′} - m / d ) {g}_{i n , x} [ {λ}_{{R}^{′}} ( u + n / d + {u}^{′} - m / d ) , λ ] . & ( 33 )\end{matrix}$$

In equation (32), Q_{R′} designates a result of applying only the y-component of the free-space propagator to the object transmission function. The y-axis is parallel to the gratings' lines, so:

Q_{R′}(x,y)≡∫dYQ(x,y−Y)P_{R′}(Y), (34)

The superscript (1) in equation (32) denotes that the corresponding Fourier transform is taken over the first spatial variable.

In the point-projection geometry with magnification M the effective source size in the object plane is expressed via the source size w_{S} (FWHM) as follows,

w_{S,eff}=w_{S}(1−M⁻¹). (35)

The effective source size does not exceed the actual source size at any magnification M≧1.

Visibility of a self-image formed by the first grating remains good if the effective source size is much smaller than the period d of the self-image (referred hereafter to the object plane), that is,

w_{S,eff≦nd,} (36)

where n should be sufficiently smaller than unity, such as n=⅛.

Depending on the X-ray source size, two cases of practical importance can be distinguished:

i) source size does not exceed the critical value, w_{S}≦nd;
ii) source size is larger than the critical value, w_{S}>nd.

Below these two cases are considered separately. In the numerical results presented here, a rectangular profile in both gratings is assumed with the line-to-space ratio 1:1.

Firstly, it is assumed that the source size does not exceed the critical value, that is,

w_{S}≦nd. (37)

In this case there is no limit to the magnification of the system. The imaging configuration is constructed based on the following considerations. The Talbot distance, that is, the distance downstream from the first grating at which the grating produces the so-called fractional Talbot self-image, can be expressed as follows [28]:

zₘ=md₁²/(2η²λ), (38)

where d₁ is a period of the first grating, and the integer m is the Talbot order which should be odd for a phase grating and even for an amplitude grating. The factor η depends on the choice of the first grating. In the case of either a phase grating with the phase modulation φ₀=π/2 or an amplitude grating the corresponding value of the factor is η=1. In this case, the period of the self-image is equal to the period of the first grating, d=d₁. In another configuration the first phase grating has a phase modulation φ₀=π, in which case the corresponding value of η is 2 and the period of the self-image is half of the first grating period, d=d₁/2. In both cases, d=d₁/η and period d₂ of the second (amplitude) grating 16 is chosen to be equal to the period of the corresponding self-image multiplied by magnification factor M, that is, d₂=M d₁/η.

The effective object-to-detector propagation distance R′ is expressed via the magnification M and source-to-detector distance R as

R′=M⁻²(M−1)/R. (39)

If it is assumed that period d₂ of the amplitude grating is an independent parameter, the period of the phase grating is defined as d₁=ηd₂/M. Equating the effective distance R′ (cf. equation (39)) and the Talbot distance zₘ (cf. equation (38)), one obtains the appropriate magnification:

M=1+md₂²/(2λR). (40)

The ability of apparatus 10 to detect small deflections of the wave propagated through the object 26 depends on the angular acceptance of the period of the self-image as seen from the object, that is, d/R′. The smaller is this ratio, the more sensitive is apparatus 10 to small deflection angles. This angular acceptance can be presented in terms of d₂, λ and R as:

d/R′=d₂/R+2λ/(md₂). (41)

An analysis of equation (41) shows that, for fixed R and λ, the ratio d/R′ has large values for both small and large values of d₂ and has a minimum at the optimum value of d₂. Thus,

$${( {d}_{2} )}_{opt} = {( 2 λ R / m )}^{1 / 2} , {( d / {R}^{′} )}_{m i n} = {2 [ 2 λ / ( mR ) ]}^{1 / 2} . \qquad ( 42 )$$

Equation (42) indicates that the angular acceptance of the self-image period can be improved (i.e. decreased) by either decreasing the X-ray wavelength λ or by increasing the total distance R. Noting that the deflection angles due to the object are inversely proportional to the second power of λ, the contrast of the images decreases for smaller wavelengths as λ^{3/2}. Also, only large increases in the total distance can result in a significant improvement in the contrast; for example, to double the differential contrast, R should be increased four times. According to equation (40), the optimum period of the second grating (d₂)ₒₚₜ corresponds to magnification M=2 independently of X-ray energy and total distance. According to equation (37), the maximum allowable source size corresponding to the optimum period (d₂)ₒₚₜ is w_{S,max}=(n/2)(2λR/m)^{1/2}. The optimum period (d₂)ₒₚₜ not only minimises the ratio d/R′ but also maximises the period of the self image d, namely

dₘₐₓ=(d₂)ₒₚₜ/2. (43)

The case where R=250 mm, d₂=24 μm, λ=3 Å and m=1 is considered as an example. According to equation (40) the corresponding magnification is M=4.84. At the same time the source size should satisfy equation (37); assuming n=1/8 this gives w_{S}≦0.62 μm. These and other important geometrical parameters are summarized in Table 1 (in which C′=(Iₘₐₓ−Iₘᵢₙ)/2 is the contrast in the images).

TABLE 1
Geometrical parameters of apparatus 10 with
R = 250 mm, m = 1 and wₛ = d/8

| d₂ | λ | | d | wₛ | R′ | R₁ | R₂ | d/R′ | |
|---|---|---|---|---|---|---|---|---|---|
| (μm) | (Å) | M | (μm) | (μm) | (mm) | (mm) | (mm) | (”) | C′ |
| 6 | 3 | 1.24 | 4.84 | 0.605 | 39.02 | 201.6 | 48.4 | 25.6 | 5.91% |
| 12 | 3 | 1.96 | 6.12 | 0.765 | 62.47 | 127.6 | 122.4 | 20.2 | 7.47% |
| 24 | 3 | 4.84 | 4.96 | 0.62 | 40.98 | 51.7 | 198.3 | 25 | 6.05% |
| 48 | 3 | 16.36 | 2.93 | 0.37 | 14.35 | 15.3 | 234.7 | 42.1 | 3.59% |
| 9 | 1.5 | 2.08 | 4.327 | 0.541 | 62.41 | 120.2 | 129.8 | 14.3 | 2.65% |
| 12 | 1.5 | 2.92 | 4.11 | 0.51 | 56.30 | 85.6 | 164.4 | 15.1 | 2.51% |

Analysis of equations (40) to (43) and of the data in Table 1 reveals the following trends in imaging with apparatus 10 according to the present invention, when using an ultra small X-ray source and a fixed source-to-detector distance. Firstly, given a fixed X-ray energy (e.g. λ=3 Å), increasing the period of the second (amplitude) grating 16 results in almost quadratic increase of the magnification: M=1.96 in the case of d₂=12 μm, M=4.84 in the case of d₂=24 μm and =16.36 in the case of d₂=48 μm. The first of these values, namely d₂=12 μm, is close to the optimum value (cf. equation (42)), (d₂)ₒₚₜ=12.25 μm for the chosen R=250 mm and λ=3 Å. The maximum source size and contrast decrease both with decrease and increase of d₂.

Secondly, the above two schemes, corresponding to the two values of the phase modulation of the phase grating, π/2 and π, are virtually identical, differing only in the period of the phase grating. It is twice as large in the scheme with phase modulation equal to π. However, the aspect ratio in the height profile of phase grating 14 is the same for both cases as the twice larger phase modulation is achieved by two times higher thickness profile in the phase grating.

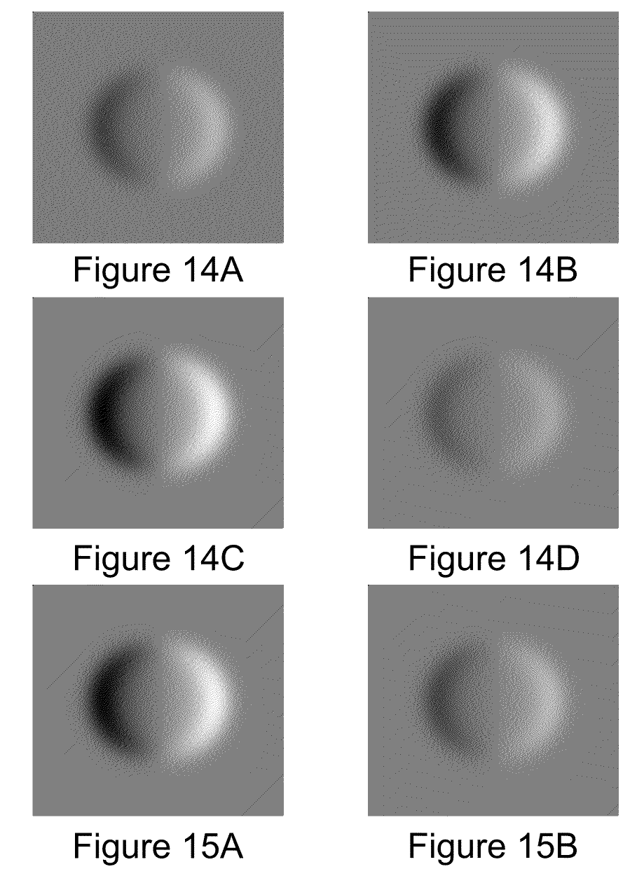

Thirdly, increasing X-ray energy (with fixed amplitude grating period) results in a decrease in the period of the self-image, in the maximum allowable source size and in the contrast in the images (cf. FIGS. 14C and 14D). The latter means that there is a trade-off between radiation dose absorbed by an object and the effectiveness of the method implemented by apparatus 10.

With a source that is larger than the critical value, that is,

w_{S>nd,} (44)

demagnification of the source is needed, and the effective source size in the object plane is given by equation (35). It follows from equations (35) and (36) that the maximum magnification that satisfies the condition that the effective source size does not exceed the critical size nd is:

Mₘₐₓ=(1−nd/w_{S})⁻¹. (45)

According to equation (45), at a given self-image period, the larger the source size the closer to unity should be the magnification. Treating the period d₂=Md of the second (amplitude) grating 16 as an independent variable, the maximum magnification Mₘₐₓ that still satisfies equation (36) is:

Mₘₐₓ=1+nd₂/w_{S}. (46)

The total distance R and the angular acceptance of the period of the self-image d/R′ may be expressed as:

R=md₂²/[2λ(M−1)], d/R′=2λM/(md₂). (47)

Equation (47) indicates opposite dependencies of the total distance and angular acceptance on every of the three parameters, d₂, λ and M. For example, the maximum allowable magnification Mₘₐₓ (cf. equation (46)) minimizes the total distance and, if it is assumed that Mₘₐₓ does not exceed 2 then the maximum increase of the ratio d/R′ due to the magnification factor is 2 (and in fact that the optimum magnification minimizing this ratio is 1). If it is assumed that M=Mₘₐₓ, equation (47) may be transformed thus:

R=md₂w_{S}/(2nλ), d/R′=(2λ/m)[(1/d₂)+(n/w_{S})]. (48)

Equation (48) shows that the total distance can only be decreased by decreasing the source size, w_{S}, decreasing the second grating period, d₂, and increasing the X-ray wavelength λ. However, decreasing both w_{S} and d₂ results in an increase in the ratio d/R′ and, as a result, in a decrease in the contrast. Notwithstanding the increase of the ratio d/R′ with X-ray wavelength, the overall effect of the wavelength is positive for the contrast (i.e. differential contrast is proportional to λ). It should be noted, however, that the total absorbed dose increases significantly with the increase of λ (that is, the linear absorption coefficient is approximately proportional to λ³). Thus there are two tradeoffs, the first between the contrast and the total distance, the second between the contrast and the absorbed dose. Some exemplary calculations of the geometrical parameters based on equations (45) to (48) are given in Table 2.

TABLE 2
Geometrical parameters of the double-grating
imaging system with m = 1

| wₛ | d₂ | λ | | d | R′ | | R | R₂ |
|---|---|---|---|---|---|---|---|---|
| (μm) | (μm) | (Å) | Mₘₐₓ | (μm) | (mm) | d/R′ (”) | (mm) | (mm) |
| 100 | 16 | 1 | 1.02 | 15.69 | 1230.3 | 2.63 | 64,000 | 1254.9 |
| 100 | 8 | 1 | 1.01 | 7.92 | 313.69 | 5.21 | 32,000 | 316.8 |
| 100 | 4 | 1 | 1.005 | 3.98 | 79.21 | 10.36 | 16,000 | 79.6 |
| 10 | 8 | 1 | 1.1 | 7.27 | 264.46 | 5.67 | 3,200 | 290.9 |
| 5 | 16 | 1 | 1.4 | 11.43 | 653 | 3.61 | 3,200 | 914.3 |
| 5 | 8 | 0.5 | 1.2 | 6.67 | 444 | 3.10 | 3,200 | 532.8 |
| 5 | 8 | 1 | 1.2 | 6.67 | 222 | 6.19 | 1,600 | 266.4 |
| 5 | 4 | 1 | 1.1 | 3.64 | 66.1 | 11.36 | 800 | 72.7 |

R₂ = m d₂²/(2λ) [1 + nd₂/wₛ]⁻¹

The following three practically important trends can be established by analysing equations (46) to (48) and the data in Table 2. Firstly, for fixed values of the period of the second grating and X-ray wavelength (d₂=8 μm, λ=1 Å) but increasing source size, the self-image period d and the distance between the gratings R₂ increase only slightly. The total source-to-detector distance R is proportional to the source size (cf. equation (48)): it is about 1.6 m for the 5 micron source, 3.2 m for the 10 micron source and 32 m for the 100 micron source. At the same time, the angular acceptance d/R′ slightly decreases with the source size; this results only in slight improvement of the contrast in the resulting images. Thus, in order to use apparatus 10 in laboratory conditions (where the total source-to-detector distance is typically limited to several metres) the source size should not exceed ˜10 μm. If the total source-to-detector distance can be made significantly larger, of the order—for example—of 20 to 100 m (such as at a synchrotron), the source size can be of the order of 100 μm (typical for most modern synchrotrons). The potential improvement in the contrast by employing large distances and large source sizes is moderate. The greatest advantage of using large sources (such as synchrotrons) is many orders of magnitude higher flux in the incident beam.

Also, in order to be able to use standard (laboratory) X-ray sources, with a focus size of the order of several hundred microns, an additional amplitude grating may be mounted in front of the source. FIG. 3 is a schematic, plan view of a scanning imaging apparatus 40 in accordance with an alternative embodiment of the present invention. Apparatus 40 is comparable to apparatus 10 of FIGS. 1A to 1C, and like reference numerals have been used to identify like features. In addition, however, apparatus 40 includes an additional (amplitude) grating 42 in front of source 12, and hence between source 12 and first grating 14. Apparatus 40 is illustrated in FIG. 3 in the Δx=0 configuration. The period d₀ of additional grating 42 is calculated according to the formula, d₀=(R₁/R₂)d₂. Such a grating produces an array of line sourcelets whose width (the width of a transparent part of the grating period) should be chosen appropriately, according to the considerations discussed above. This should provide high grating performance in terms of fringe visibility in the self-image and contrast in the image of the object formed by each individual sourcelet. It should be noted, however, that the overall system resolution in this case is limited by the total size of source 12, not the size of an individual sourcelet.

Secondly, for fixed source size and X-ray wavelength (λ=1 Å, w_{S}=5 μm or 100 μm) but decreasing amplitude grating period (d₂=16 μm, 8 μm and 4 μm), the period of the self-image decreases almost linearly with d₂. Furthermore, the distance R₂ between the gratings decreases almost as the second power of d₂: it is about 0.91 m for the 16 micron period, about 0.27 m for the 8 micron period and about 0.07 m for the 4 micron period. This reduction in the distance between the gratings is, however, accompanied by linear increase of the ratio d/R′ and results in linear decrease of the contrast in the images. The source-to-detector distance R also decreases linearly with decrease of d₂. Thus, the amplitude and phase grating with small period are preferable as this allows one to minimize significantly the overall size of apparatus 10. This compactness, however, is achieved at the expense of the effectiveness (viz. image contrast) of apparatus 10.

Thirdly, decreasing X-ray wavelength (by using more energetic X-rays) does not affect the self-image period but results in inversely proportional increase of both the R and R₂. Notwithstanding that the ratio d/R′ decreases two times owing to the two times decrease in wavelength, the contrast in the images decreases two times (see FIGS. 15A and 15B).

### EXAMPLES

Firstly, numerical experiments (viz. simulations of apparatus 10) and comparative examples were conducted using rigorous wave-optical theory based on Fresnel diffraction formula, in various imaging configurations.

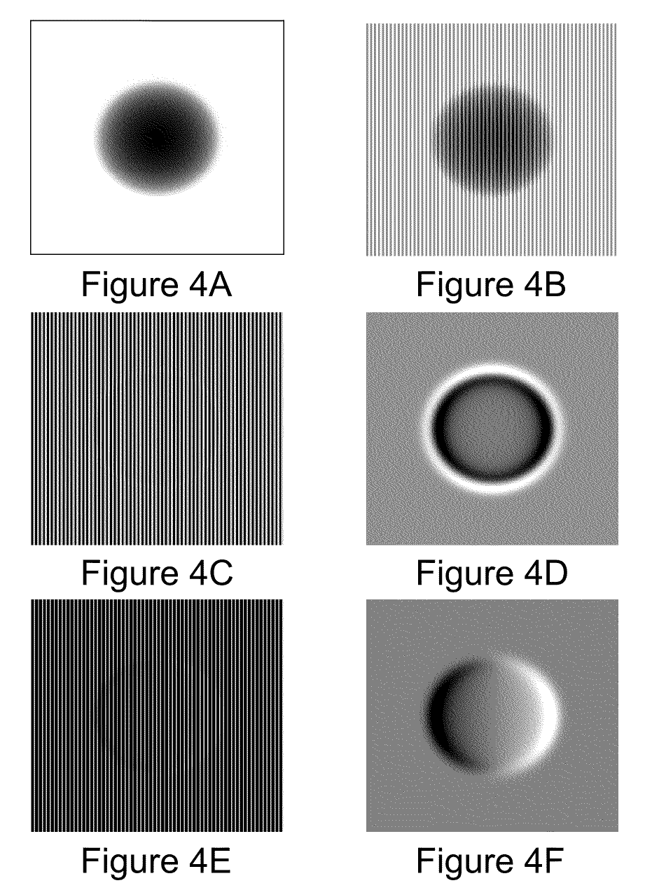

In the first set of simulations, gratings 14, 16 were simulated as stationary during image collection, as having the same period of rectangular modulation, d=8 μm, and as having the same line-to-space ratio, 1:1; an X-ray wavelength of λ=0.62 Å, corresponding to an energy of 20 keV, was employed. The maximum phase shift of the phase grating (i.e. first grating 14) was n/2. The distance between first and second gratings 14, 16 was R₂=d²/(2λ)=0.516 m. This is the distance at which a self-image of the phase grating 14 is produced [17]. An object 26 comprising a pure phase-object sphere of diameter 250 μm, radially smeared with a Gaussian function of 12.5 μm FWHM, and maximum phase shift of −2 rad, was simulated. A plane incident wave was assumed in this and subsequent simulations. The calculated, projected phase of the sphere is shown in FIG. 4A, while FIG. 4B shows the phase of the wave immediately after (phase) first grating 14.

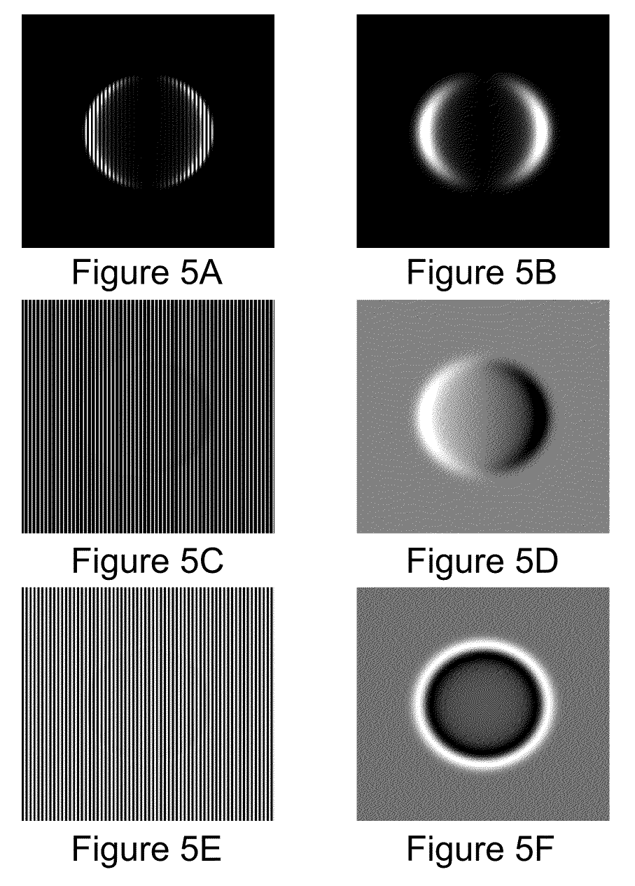

Images of the sphere, as a first comparative example, corresponding to a perfect detector and for different values of the relative shift along the x-axis, Δx=x₂−x₁, of (amplitude) second grating 16 with respect to first grating 14 are shown in FIGS. 4C, 4E, 5A and 5C. Further images according to this comparative example, corresponding to a finite-resolution detector, are shown in FIGS. 4D, 4F, 5B and 5D; these were obtained by convolving the corresponding images in FIGS. 4C, 4E, 5A and 5C with a Gaussian function of 20 μm FWHM to simulate the more limited resolution arising from instrumental blurring. FIGS. 5E and 5F show the results of adding the four unconvolved images (of FIGS. 4C, 4E, 5A and 5C) and the four convolved images (of FIGS. 4D, 4F, 5B and 5D). Some of the image characteristics of the convolved images are presented in Table 3.

TABLE 3
Image characteristics

| FIG. | Δx | Iₘᵢₙ | Iₘₐₓ | C′ = (Iₘₐₓ − Iₘᵢₙ )/2 |
|---|---|---|---|---|
| 4D | 0 | 0.9899 | 1.008 | 0.91% |
| 4F | d/4 | 0.428 | 0.5706 | 7.13% |
| 5B | 2d/4 | 0 | 0.0059 | 0.30% |
| 5D | 3d/4 | 0.428 | 0.5706 | 7.13% |

It should be emphasized that finite resolution of the detector (i.e. that the detector pixel size should be larger than period of the gratings) is necessary for observing images without Talbot fringes. Thus, the resolution obtained by these background techniques cannot in principle be improved.

The second set of simulations corresponds to the scanning-double-grating imaging modality provided by apparatus 10 of FIGS. 1A and 1B, and hence according the present invention. Simulated images were calculated of the same sphere (of diameter 250 μm) for different positions, x₁ and x₂ respectively, of first and second gratings 14, 16, with the relative shift Δx=x₂−x₁ constant in each case.

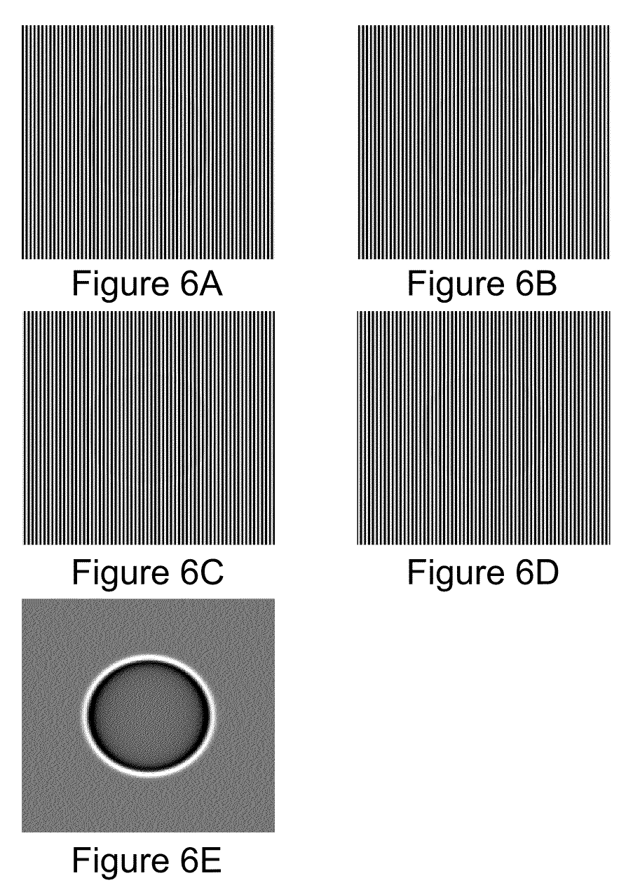

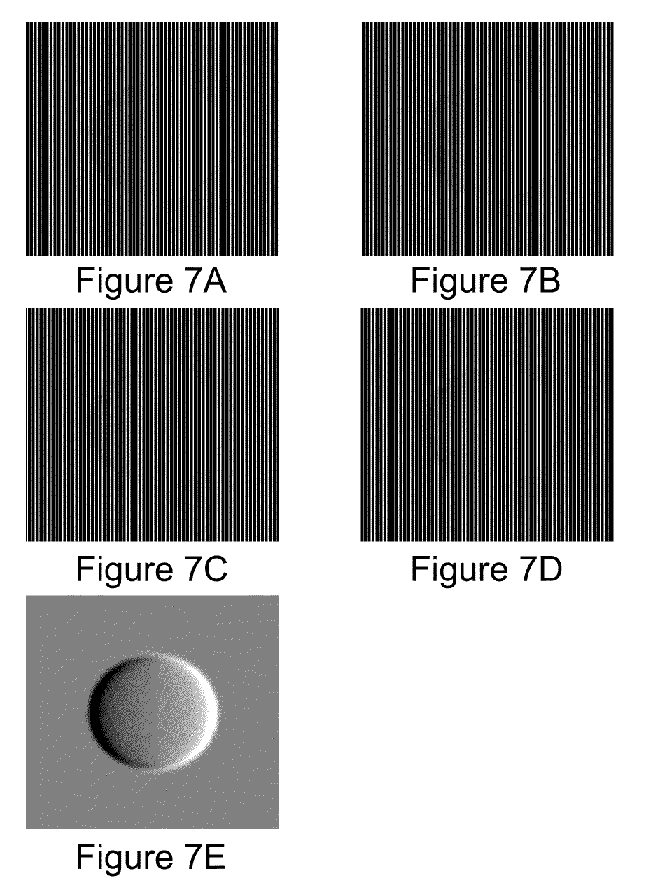

The results corresponding to four values of Δx are presented in FIGS. 6A to 9E. FIGS. 6A to 6D are simulated images of the sphere, for a relative grating position of Δx=0 and respective grating positions of x₁=0, x₂=0; x₁=d/4, x₂=d/4; x₁=2d/4, x₂=2d/4; and x₁=3d/4, x₂=3d/4. FIG. 6E is a simulated image comprising the sum of these four Δx=0 images. Similarly, FIGS. 7A to 7D are simulated images of the sphere for a relative grating position of Δx=d/4 and respective grating positions of x₁=0, x₂=d/4; x₁=d/4, x₂=2d/4; x₁=2d/4, x₂=3d/4; and x₁=3d/4, x₂=0. FIG. 7E is a simulated image comprising the sum of these four Δx=d/4 images.

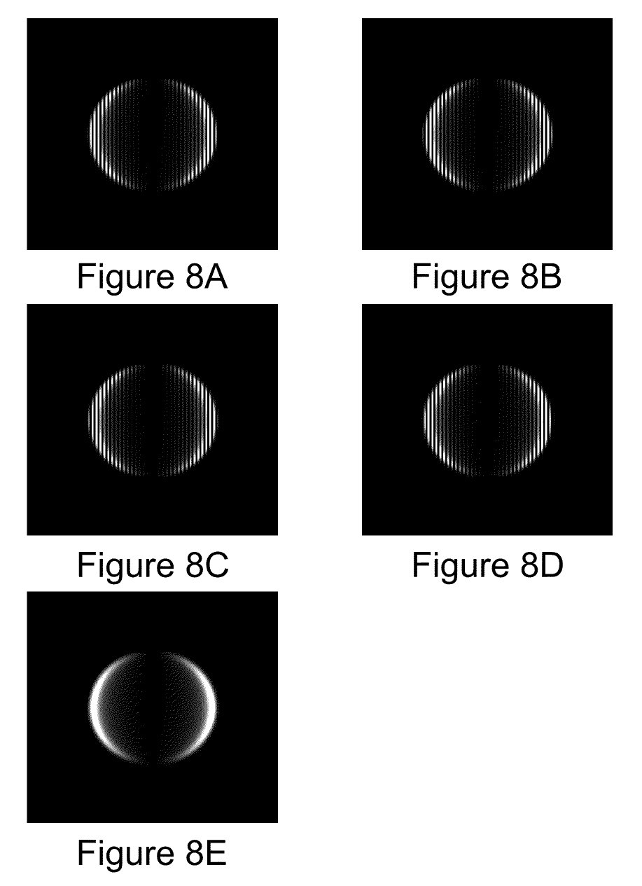

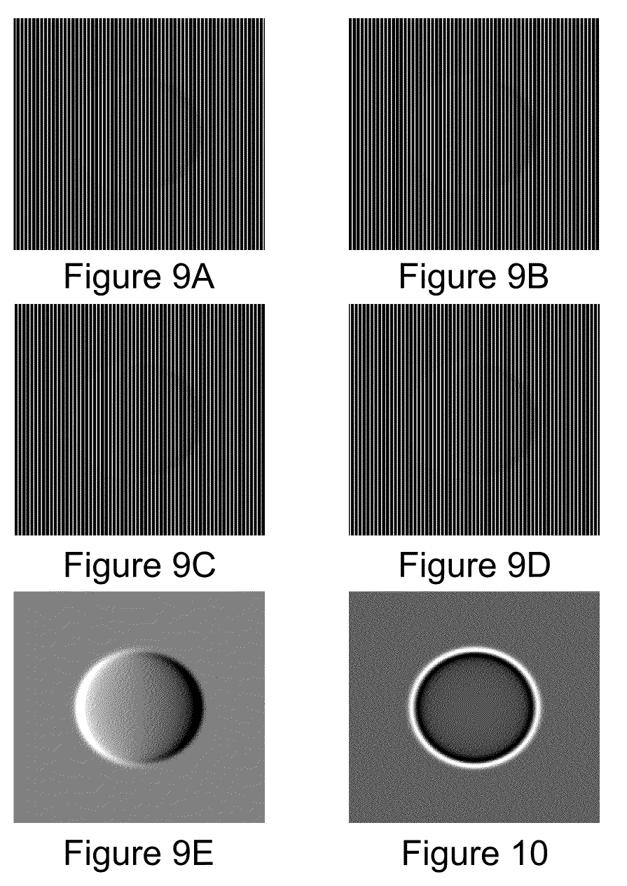

FIGS. 8A to 8D are simulated images of the sphere for a relative grating position of Δx=2d/4 and respective grating positions of x₁=0, x₂=2d/4; x₁=d/4, x₂=3d/4; x₁=2d/4, x₂=0; and x₁=3d/4, x₂=d/4. FIG. 8E is a simulated image comprising the sum of these four Δx=2d/4 images. FIGS. 9A to 9D are simulated images of the sphere for a relative grating position of Δx=3d/4 and respective grating positions of x₁=0, x₂=3d/4; x₁=d/4, x₂=0; x₁=2d/4, x₂=d/4; and x₁=3d/4, x₂=2d/4. FIG. 9E is a simulated image comprising the sum of these four Δx=3d/4 images.

In the images of FIGS. 6A to 6D (corresponding to Δx=0), the only visible effect of the shift in the x direction is a shift of the Talbot fringes. The image of FIG. 6E—showing the sum of these four images—is a direct analogue of the comparative example of FIG. 4D, though without smearing. The improvement in resolution and contrast is noticeable (cf. also Table 4). Thus the resolution in this method can—according to the present embodiment—be significantly improved compared with that of the comparative example of FIGS. 4D, 4F, 5B and 5D by using high-resolution detector. The only limitation on the resolution is due to the effect of diffraction.

TABLE 4
Image characteristics

| FIG. | Δx | Iₘᵢₙ | Iₘₐₓ | C′ = (Iₘₐₓ − Iₘᵢₙ )/2 |
|---|---|---|---|---|
| 6E | 0 | 0.9792 | 1.027 | 2.39% |
| 7E | d/4 | 0.3958 | 0.6034 | 10.38% |
| 8E | 2d/4 | 0 | 0.01057 | 0.53% |
| 9E | 3d/4 | 0.3958 | 0.6034 | 10.38% |

FIG. 10 is the sum of the four images of the sphere shown in FIGS. 6E, 7E, 8E and 9E and simulated according to the present embodiment; it shows in-line contrast for the sphere due to free-space propagation. The image is simulated as recorded a distance z=0.516 m from the sphere.

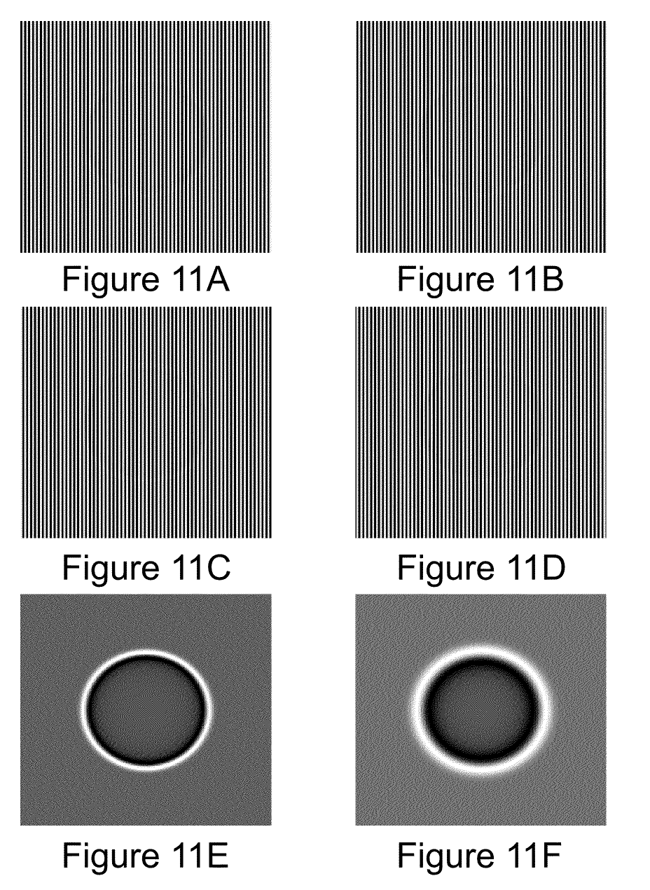

As a second comparative example, simulated images were calculated corresponding to the single phase grating imaging method proposed by Takeda et al. [18]. In this method only a phase grating is used, and the detector is assumed to have a resolution better than the period of the grating (so that the self-image of the phase grating is resolved by the detector). According to this technique, several images corresponding to different positions of the grating are collected and the phase derivative map is obtained by processing these images and the corresponding flat-field images. The results of simulations of the images of the same sphere used in generating FIGS. 4A to 10 and this background art method are presented in FIGS. 11A to 11D; these figures show the images of the sphere at four equidistant positions of the phase grating, viz. x₁=0, x₁=d/4, x₁=2d/4 and x₁=3d/4 respectively.

The images of FIGS. 11A to 11D are essentially non-informative visually. The sum of these images is presented in FIG. 11E, and gives a pure in-line image. The result of smearing any of the images is shown in FIG. 11F, obtained by convolving with a Gaussian function with 20 μm FWHM; it comprises a smeared in-line image.

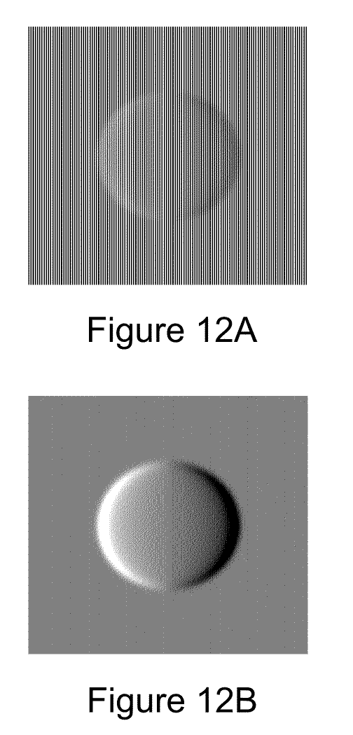

The result of applying equation (9) of Takeda et al. [18] to the images of FIGS. 11A to 11D is shown in FIG. 12A. The differential contrast (the only contrast that can be obtained by that method) is hidden by the carrier fringes. According to Takeda et al., this carrier fringe pattern can be removed by subtracting the corresponding map obtained from flat-field images. FIG. 12B is the result of smearing the image of FIG. 12A with a Gaussian function with 4 μm FWHM.

The inventive example (see FIGS. 6A to 10) reveal the advantages of apparatus 10 and the method implemented thereby over the methods of the comparative examples (see FIGS. 4A to 5F and 11A to 12B). They demonstrate that apparatus 10 can obtain a high-resolution image (in contrast to the method of the first comparative example) using a single scan of a pair of gratings, without any need for collecting multiple images and the subsequent processing of them (as in the method of the second comparative example, proposed by Takeda et al.).

It may be noted that visibility in a self-image of the phase grating is also influenced by source size. Visibility is 100% in the case of point source, 79% in the case of a 2 μm FWHM Gaussian effective source in the self-image plane (equal to d/4) and 29% in the case of a 4 μm FWHM Gaussian effective source (equal to d/2).

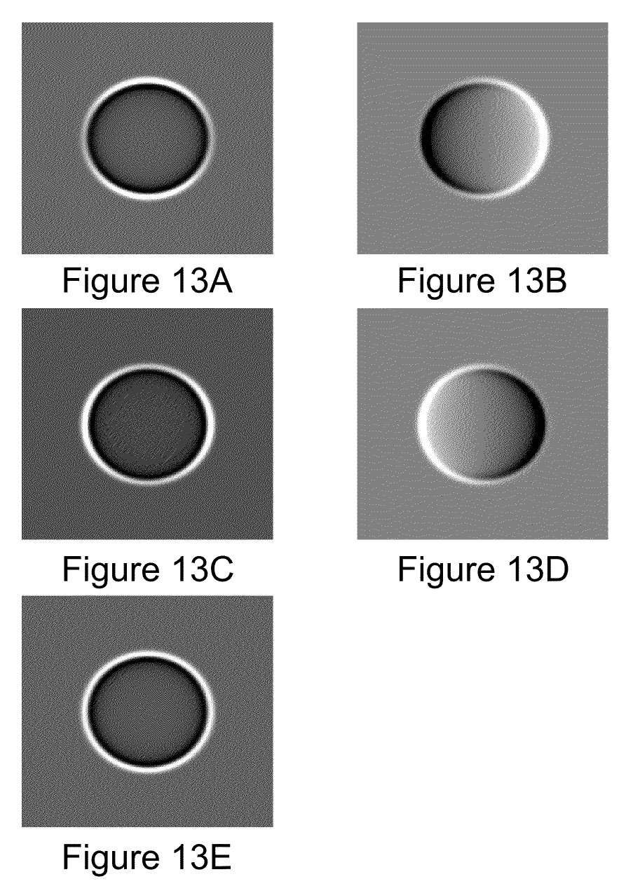

The latter was simulated in a second example according to the present embodiment; the results are shown in FIGS. 13A to 13E. FIGS. 13A to 13D are simulated images of the same sphere (of diameter 250 μm) collected with apparatus 10 of FIG. 1A. Respective relative grating positions of Δx=0, Δx=d/4, Δx=2d/4 and Δx=3d/4 were employed. FIG. 13E is a calculated image of the sphere comprising the sum of the four images of FIGS. 13A to 13D. Resulting image characteristics are presented in Table 5, as are the comparable characteristics for the case of a 2 μm FWHM Gaussian effective source in Table 6 (though the corresponding images are not).

TABLE 5
Image characteristics (Gaussian effective
source with 4 μm FWHM)

| FIG. | Δx | Iₘᵢₙ | Iₘₐₓ | C′ = (Iₘₐₓ − Iₘᵢₙ )/2 |
|---|---|---|---|---|
| 13A | 0 | 0.6373 | 0.6613 | 1.20% |
| 13B | d/4 | 0.4672 | 0.5318 | 3.23% |
| 13C | 2d/4 | 0.3482 | 0.3702 | 1.10% |
| 13D | 3d/4 | 0.4672 | 0.5318 | 3.23% |

TABLE 6
Image characteristics (Gaussian effective
source with 2 μm FWHM)

| Δx | Iₘᵢₙ | Iₘₐₓ | C′ = (Iₘₐₓ − Iₘₐₓ )/2 |
|---|---|---|---|
| 0 | 0.8773 | 0.9168 | 1.98% |
| d/4 | 0.4182 | 0.5807 | 8.13% |
| 2d/4 | 0.105 | 0.1175 | 0.63% |
| 3d/4 | 0.4182 | 0.5807 | 8.13% |

A comparison of the data of Tables 4 to 6 shows that differential contrast (observed at Δx=d/4 or 3d/4) is reduced by a factor of 0.78 in the case of the 2 μm effective source and by a factor of 0.31 in the case of the 4 μm effective source. These values almost coincide with the above mentioned visibility values in the self-image of the phase grating. Thus, in order to maximize the performance of apparatus 10, the effective source size (relative to the image plane) is desirably less than a quarter of the period of the self-image of the phase grating (which is usually equal to the period or half-period of the phase grating multiplied by magnification). In this context, an imaging geometry with a source-to-object distance larger than the object-to-detector distance (i.e. with magnification less than 2) is desirable. It should be noted, however, that in this case detector resolution becomes important. The detector resolution should be the same (or better) as the effective source size in the image plane. This would result in the best possible resolution of the imaging system.

Secondly, further simulated images were generated according to the embodiment of FIG. 1A and an object comprising a sphere of diameter 0.5 mm. Unlike in the examples of FIGS. 6A to 10 and 13A to 13E (where the motion of first and second gratings 14, 16 was simulated by summing images at a sequence of x positions), these examples involved simulating first and second gratings 14, 16 as moving according the method implemented by apparatus 10.

FIGS. 14A to 14D are simulated images of a pure phase sphere of diameter 0.5 mm (maximum phase shift is 12 rad at the wavelength λ=3 Å) radially smeared using a Gaussian function with 100 μm FWHM, and simulating apparatus 10 with Δx=d/4, the geometrical parameters of Table 1, λ=3 Å, d₂=48 μm, λ=3 Å, d₂=24 μm, λ=3 Å, d₂=12 μm, and λ=1.5 Å, d₂=12 μm respectively, a finite source, w_{S}=d/8, and an ideal detector. The contrast in the images C′ was calculated using the formula C′≡(Iₘₐₓ−Iₘᵢₙ)/2, where Iₘₐₓ and Iₘᵢₙ are correspondingly the maximum and minimum intensity values in the images of the object.

FIGS. 15A and 15B are simulated images of the same sphere of diameter 0.5 mm, radially smeared using a Gaussian function with 100 μm FWHM, simulating apparatus 10 with Δx=d/4, the geometrical parameters of Table 2 (i.e. w_{S}=5 μm and d₂=8 μm), and λ=1 Å and 0.5 Å respectively.

The observed reduction of contrast in the image calculated using a wavelength of 0.5 Å (C′=1.35% in FIG. 15B) as compared to the image calculated using a wavelength of 1 Å (C′=2.7% in FIG. 15A) is due to the fact that the deflection angles induced by the object decrease four times. This is because the deflection angle is proportional to λ². Thus, increasing X-ray energy delivers significantly smaller radiation dose to the sample (the linear absorption coefficient being inversely proportional to the third power of the X-ray energy), but the performance of apparatus 10 (i.e. image contrast) decreases linearly with the X-ray energy.

The effect of polychromaticity of X-ray radiation incident onto the object was investigated in terms of its influence on the scanning double-grating imaging. The following three issues were taken into account when dealing with polychromatic incident radiation [27,29]:

1. The complex transmission function of an object is wavelength dependent. In the case where the whole spectrum of the source is far from the absorption edges of the materials constituting the object, a phase induced by the object varies linearly with the wavelength and an absorption coefficient varies as the third power of the wavelength.

2. The phase induced by the first (phase) grating varies linearly with the X-ray wavelength (assuming that the whole spectrum of the source is far from the absorption edges of the material of the phase grating). The thickness of the lines in the second (amplitude) grating 16 is assumed to be sufficiently large that the transmittance of the lines in the grating is zero for all the energies in the spectrum of the source.

3. The Talbot distances are inversely proportional to the X-ray wavelength. Hence, if the distance between the gratings is equal to one of the Talbot distances for a particular wavelength and a self-image is observed for that wavelength, the chosen (fixed) distance does not coincide with Talbot distances for other wavelengths. The first and the third issues have been addressed by Momose et al. [29]. Based on simple considerations, they have formulated the following condition for the maximum allowable polychromaticity in the standard (non-scanning) grating-based imaging with φ₀=π/2,

Δλ/λ<⅛. (49)

Weitkamp et al. [27] have shown that in the double-grating scheme with the phase shift modulation φ₀=π the maximum allowable polychromaticity, that preserves efficiency of the interferometer, is defined as follows,

Δλ/λ<1/(2m−1), (50)

where m=1, 3, 5, . . . is the order of the Talbot distance used. However, dispersion in the object and in the gratings has been ignored in this estimation; the dispersion effects in the gratings have been assessed in [27] using numerical simulations.

In order to provide some quantitative insight into the problem of the effect of the polychromaticity on image formation with apparatus 10, the following further numerical simulations were performed. Images of a simple pure phase spherical object with the diameter 0.5 mm smeared with a 100 μm (FWHM) Gaussian function were calculated using rigorous wave-optical formalism. The maximum phase shift due to the object at the wavelength λ=3 Å was 12 radians. The phase modulation in the first (phase) grating 14 was n/2 at the wavelength 3 Å. The period d of the gratings was 8 μm. The corresponding Talbot distance was calculated using equation (38) with m=1 and η=1, z₁=d²/(2λ)=0.107 m.

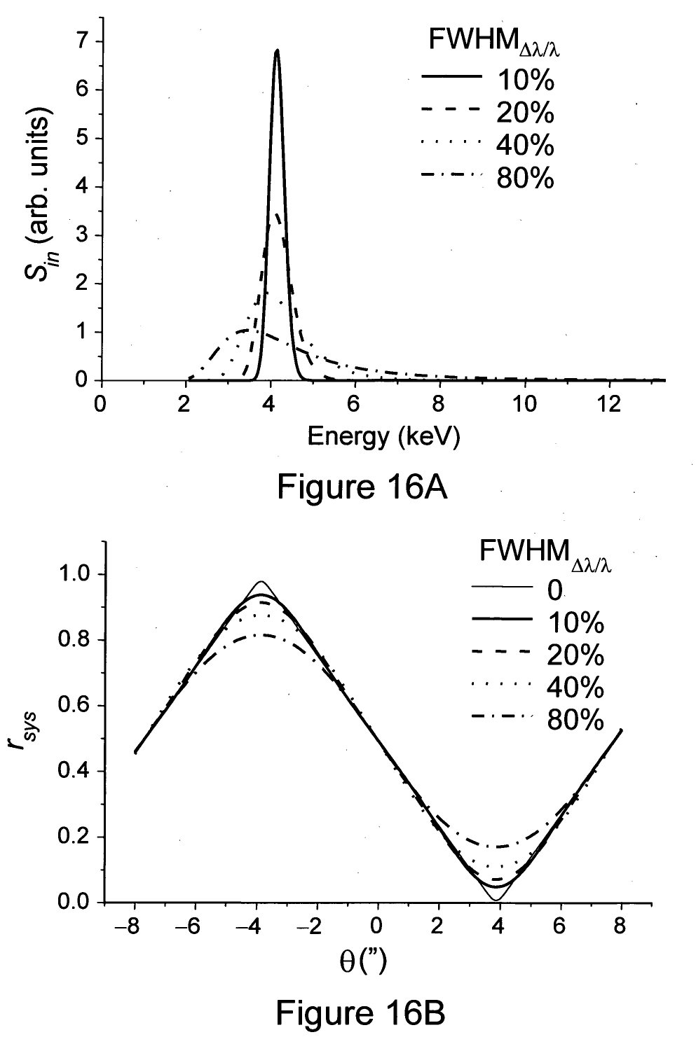

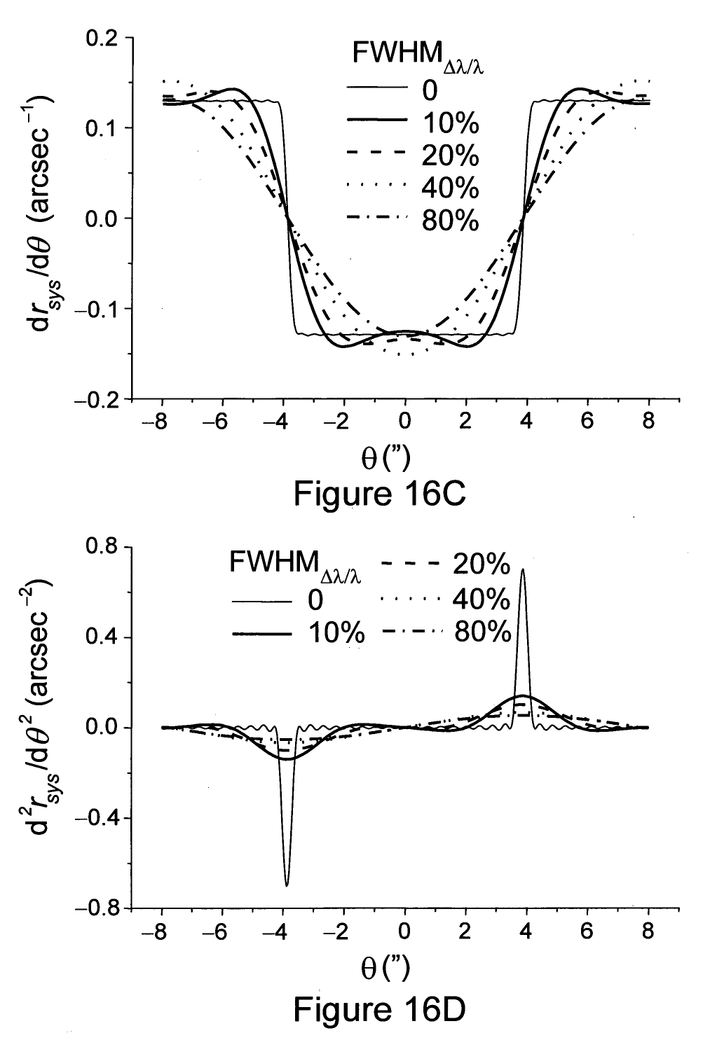

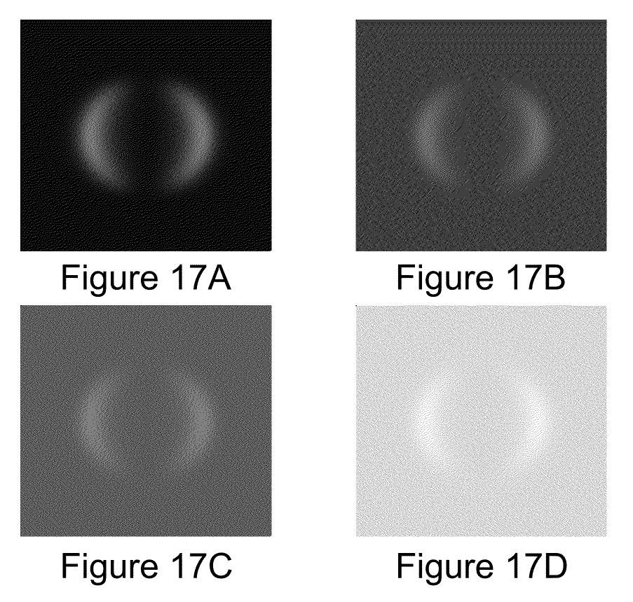

Several spectrums (Gaussian distributions for the wavelength with the average value 3 Å) were generated, and are plotted in FIG. 16A. The differential (Δx=d/4) and dark-field (Δx=d/2) images of the test object were calculated assuming monochromatic incident radiation as well as using the generated spectrums. The minimum and maximum intensities in the images together with the contrast values are summarized in Table 7. The dark-field images are shown in FIGS. 17A to 17D.

Analysis of the differential contrast images (see Table 7) has shown that at least for this particular object and for the generated (Gaussian) spectrums the differential-contrast images are almost insensitive to the polychromaticity of the source. Indeed, from Table 7, the contrast in the image corresponding to 10% spread of the wavelength is only slightly reduced compared to the case of monochromatic incident radiation and the contrast even slightly improves for other spectrums shown in FIG. 16A.

However, the dark-field images proved to be very sensitive to polychromaticity. FIGS. 17A to 17D and Table 7 show that the contrast in the dark-field images significantly degrades with the width of the spectrum (from more than 4% contrast in the monochromatic case down to about 1% contrast in the strongly polychromatic case). Also, the background intensity I_{BG} in the dark-field images increases considerably with the increase of the degree of polychromaticity.

TABLE 7
Some characteristics of the images presented in
FIGS. 17A to 17D

| | | | | |
|---|---|---|---|---|
| FWHM | | | | |
| (Δλ/λ) | Iₘᵢₙ | Iₘₐₓ | I_{BG} | C′ |

Differential contrast

| | | | | |
|---|---|---|---|---|
| 0 | 0.3944 | 0.5898 | 0.4929 | 9.77% |
| 0.1 | 0.3962 | 0.588 | | 9.59% |
| 0.2 | 0.3892 | 0.595 | | 10.29% |
| 0.4 | 0.3776 | 0.6066 | | 11.45% |
| 0.8 | 0.39 | 0.594 | | 10.2% |

Dark-field contrast

| | | | | |
|---|---|---|---|---|
| 0 | 0.007108 | 0.09192 | 0.007112 | 4.24% |
| 0.1 | 0.04771 | 0.08554 | 0.04804 | 1.89% |
| 0.2 | 0.07103 | 0.09974 | 0.07156 | 1.44% |
| 0.4 | 0.1091 | 0.1301 | 0.1099 | 1.05% |
| 0.8 | 0.1695 | 0.1913 | 0.1708 | 1.09% |

A qualitative explanation of this behaviour of the differential-contrast and dark-field images can be found by analyzing the ‘reflectivity’ curves for apparatus 10, which are plotted in FIG. 16B. According to this figure, the main effect of polychromaticity on the ‘reflectivity’ curve is in its smoothing, mostly in the vicinity of its vertices. The geometrical optics approximation (discussed above) predicts that the contrast in the differential-contrast images is proportional to the derivative of the ‘reflectivity’ in the working point which lies on its slopes. For example, the differential-contrast images were calculated using the working point positioned in the centre of the negative slope (corresponding to a zero deviation angle θ in FIG. 16B).

FIG. 16C comprises plots of the first derivative of the simulated reflectivity curves of FIG. 16B with respect to deviation angle θ. FIG. 16D comprises plots of the second derivative of the same simulated reflectivity curves with respect to deviation angle θ. An examination of FIG. 16C shows that the magnitude of the ‘reflectivity’ derivative in this working point remains almost unchanged. However, contrast in dark-field images is proportional to the second derivative of the ‘reflectivity’ curve in the working point positioned in the minima of the ‘reflectivity’ curve (corresponding to θ≈4 arcsec in FIGS. 16B to 16D). Examination of FIG. 16D shows that the magnitude of the second derivative monotonically decreases.

Optimisation of apparatus 10 may be performed according to criteria appropriate to the intended application. In medical imaging, for example, a suitable figure of merit is the signal-to-noise ratio (SNR), which can be varied by adjusting the geometrical parameters (gratings periods and magnification) of the apparatus. Indeed, such optimisation may also be applicable to other propagation based, phase contrast imaging techniques.

This optimisation may be performed according to the present invention for a single micro-focus source (with the source size not exceeding several tens of microns), or for a macro-focus source, with the source size of the order of several hundred microns. In this former case, and in the geometrical optics approximation (GOA), when the characteristic feature size in the object is much larger than the period of the self-image of the first grating (projected back onto the plane of the first grating, the later being located immediately after the object), the spectral density in the scanning double-grating image, formed by a single source (the approach in which an array of sources is used requiring separate consideration) and collected using a detector having a finite resolution, is given [30] by the expression:

M²S(Mx,My;θ)≅Sᵢₙr_{sys}[θ−k⁻¹∂ₓφ(x,y)]*P_{sys}(x,y), (51)

where Sᵢₙ is the spectral density of the intensity in the beam incident on the object, located at the distance R₁ from the source; r_{sys}(θ) is the scanning-double-grating system function (θ≡Δx/R′ being the “deviation angle” of the system which defines the working point on r_{sys}), P_{sys}(x, y) is the point-spread function (PSF) of the imaging system (entirely defined by the detector resolution, σ_{det}, in the considered case) and M is the magnification of the system, M=1+R₂/R₁, R₂ being the distance between the gratings. Hereafter, unless otherwise stated, the system PSF is referred to the object plane and is taken in the Gaussian form,

P_{sys}(x,y)=[2πσ_{sys}²(M)]⁻¹exp{−(x²+y²)/[2σ_{sys}²(M)]}, σ_{sys}²(M)=M⁻²σ_{det}². (52)

According to [30], the system function r_{sys}(θ) can be presented as a convolution of the “ideal” system function (corresponding to the point source), r_{id}(θ), with the properly rescaled intensity distribution in the source plane,

r_{sys}(θ)=∫dx′S_{src,eff}(−x′)r_{id}[θ−(x′/R′)], (53)

where S_{src,eff}(x)=(1−M⁻¹)⁻¹ S_{src}[(1−M⁻¹)⁻¹x] is the intensity distribution (normalised to unity) of the source referred to the plane of the first grating (coinciding with the object plane) and R′ is the effective propagation distance between the gratings, R′=R₁R₂/(R₁+R₂). The “ideal” system function, r_{id}, is periodical with the period Θ=d/R′, where d is the period of the self image of the first grating (demagnified to the plane of the first grating) formed in the Talbot plane located at the distance R₂ downstream from the first grating. Moreover, in the case of rectangular profiles in both gratings, with the line-to-space ratio equal to one, the “ideal” system function has the “saw-tooth” form (with the origin of the system function chosen to correspond to the so-called dark-field imaging mode in which the non-deflected X-rays are blocked-up by the double-grating system),

r_{id}(θ)=2|θ|/Θ, |θ|≦η/2. (54)

Using the Fourier series decomposition, the system function is presented as follows,

$${r}_{id} ( θ ) = \frac{1}{2} - \frac{4}{{π}^{2 }} {\sum }_{k = 0}^{∞} {( 2 k + 1 )}^{- 2} cos [ 2 π ( 2 k + 1 ) θ / Θ ] . \qquad ( 55 )$$

The corresponding Fourier series of the system function, r_{sys}, is:

$${r}_{sys} ( θ ) = \frac{1}{2} - \frac{4}{{π}^{2}} {\sum }_{k = 0}^{∞} {( 2 k + 1 )}^{- 2} cos [ 2 π ( 2 k + 1 ) θ / Θ ] {\hat{S}}_{src , eff} [ ( 2 k + 1 ) / d ] \qquad ( 56 )$$

In the case of a Gaussian distribution of the intensity in the source,

S_{src,eff}(x)=(2π)^{-1/2}σ_{src,eff}exp[−x²/(2σ_{src,eff}²)], (57)

where σ_{src,eff}=(1−M⁻¹) σ_{src}, the Fourier transform of the source intensity distribution is

Ŝ_{src,eff}(u)=exp(−2π²σ_{src,eff}²u²). (58)

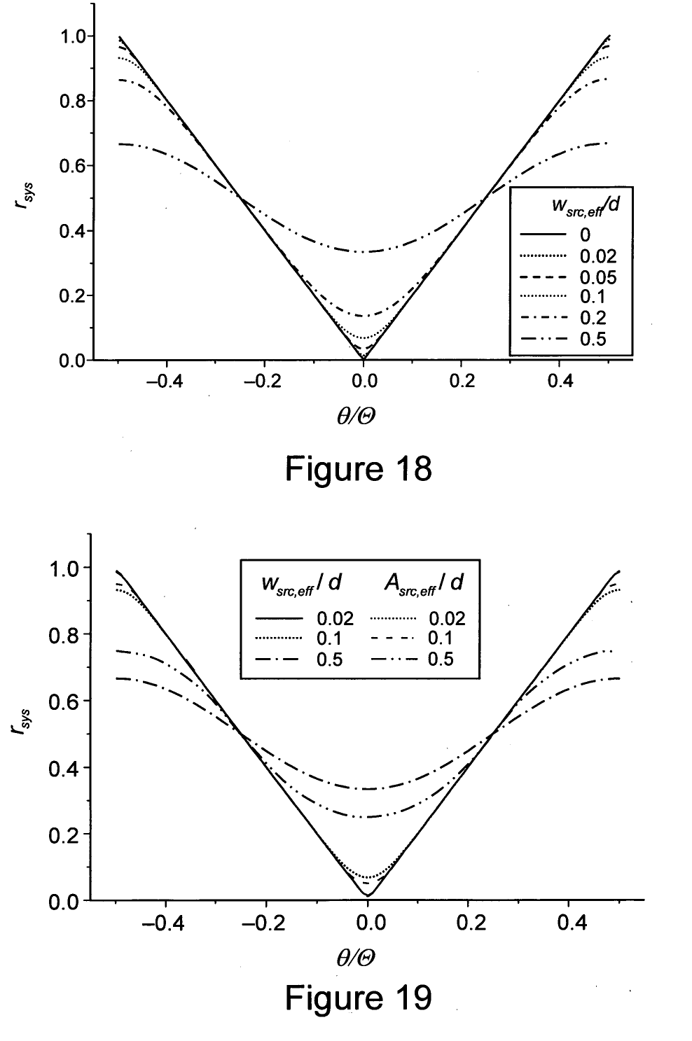

FIG. 18 shows the system function for several different values of the dimensionless parameter w_{src,eff}/d, where w_{src,eff}=(1−M⁻¹) w_{src} is the FWHM of the effective source in the plane of the first grating. FIG. 19 compares the system functions assuming Gaussian (solid lines) and rectangular (dashed lines) intensity distribution in the source. In the former case, the source size is approximated by the FWHM, w, of the distribution, while in the later case the source size is denoted by A. FIG. 19 indicates that the rectangular distribution of the same width as the FWHM of the Gaussian distribution results in a lesser smearing of the system function.

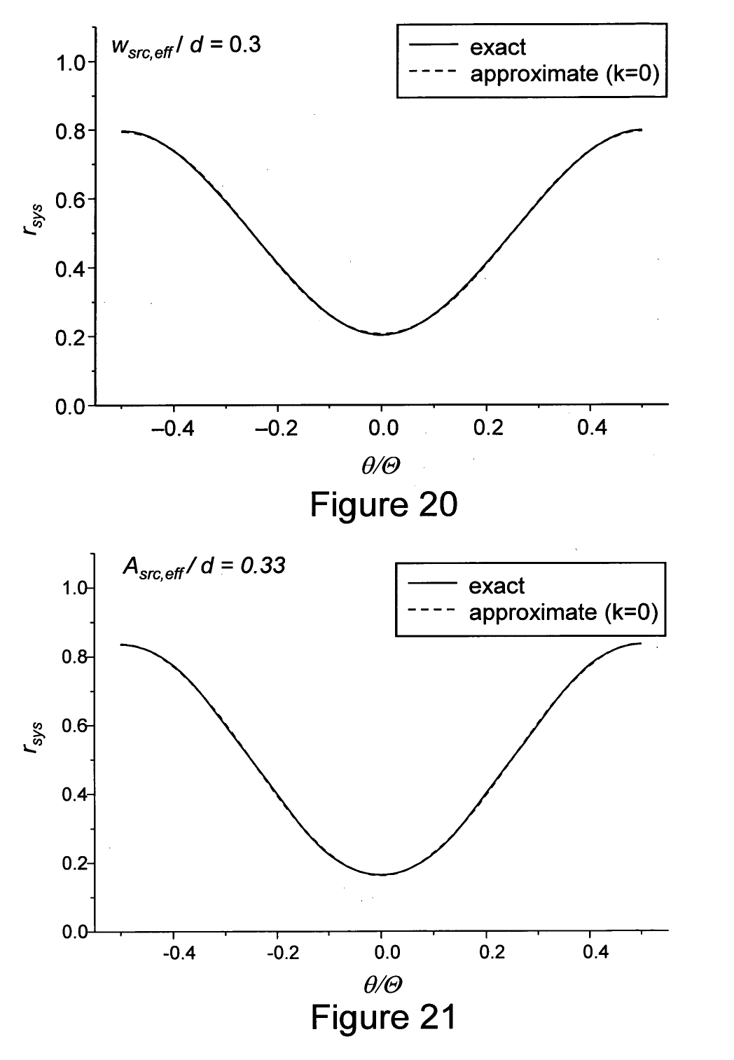

Considering the influence of the source size on the system function, it should be noted that the larger the ratio W_{src,eff}/d, the smaller is the number of terms in eq. (56) contributing to the system function. For example, in the case of a Gaussian source, if the ratio w_{src,eff}/d≧0.3 then the system function calculated using eq. (56) with only one term in the sum, k=0, differs from the exact system function, calculated using very large number of terms in eq. (56), by less than 1% (see FIG. 20). By comparison, in the case of a rectangular source, the minimum ratio A/d that guarantees that the approximate system function, calculated using only the first term in its Fourier series, differs by less than 1% from the exact one, is 0.33 (see FIG. 21). It should also be noted that visibility of the system function, shown in FIG. 21 and corresponding to the rectangular source, is slightly larger than that shown in FIG. 20 and corresponding to the Gaussian source (67% versus 59%).

In the differential-contrast regime, when the system function can be considered to be linear in a small vicinity of the working point (e.g. on the slopes of the system function), we obtain

r_{sys}[θ−k⁻¹∂ₓφ(x,y)]≈r_{sys}(θ)−k⁻¹∂ₓφ(x,y)r′_{sys}(θ), (59)

so that eq. (51) transforms into

S(Mx,My;θ)≈S₀(θ)[1−k⁻¹(r′_{sys}/r_{sys})(θ)(∂ₓφ*P_{sys})(x,y)], (60)

where S₀(θ)=M⁻²Sᵢₙ r_{sys}(θ) is the spectral density that would be measured in the absence of the object (flat-field spectral density).

Considering a model “smeared-edge” object which introduces the following phase shift to the incident wave,

φ(x,y)=−|φ|ₘₐₓ₍H*P_{obj})(x,y), (61)

where H(x) is the Heaviside step function and

P_{obj}(x,y)=(2πσ_{obj}²)⁻¹exp[−(x²+y²)/(2σ_{obj}²)].

Taking into account that

$$\begin{matrix}( {\partial }_{x} ϕ * {P}_{sys} ) ( x ) = - {\vert ϕ \vert}_{ma x} δ ( x ) * ( {P}_{obj} * {P}_{sys} ) ( x , y ) \\ = - {\vert ϕ \vert}_{ma x} {( 2 π )}^{- 1 / 2} {σ}_{M}^{- 1} exp [ - {x}^{2} / ( 2 {σ}_{M}^{2} ) ]\end{matrix}$$

where σ_{M}²=σ_{obj}²+σ_{sys}²(M) equation (60) then transforms to

S(Mx;θ)≈S₀(θ){1+k⁻¹|σ|ₘₐₓ₍2π)^{-1/2}σ_{M}⁻¹exp[−x²(2σ_{M}²)](r′_{sys}/r_{sys})(θ)}. (62)

The signal, in the integral sense, is defined as

$$\begin{matrix}\sum = {ML}_{y} {\int }_{- Ma}^{Ma} d {x}^{′} \vert S ( {x}^{′} ) - {S}_{0} \vert \\ = {L}_{y} {S}_{i n} {k}^{- 1} {\vert ϕ \vert}_{ma x} \vert {r}_{sys }^{′} \vert erf [ a / ( {2}^{1 / 2} {σ}_{M } ) ] .\end{matrix} \qquad ( 63 )$$

The noise is calculated using Poisson statistics as

N=\sqrt{4SᵢₙaL_{y}r_{sys}}. (64)

The SNR is then equal to

$$SNR = {( 2 k )}^{- 1} \sqrt{{L}_{y} {S}_{i n} {r}_{sys}^{- 1}} {\vert ϕ \vert}_{ma x} \vert {r}_{sys}^{′} \vert \frac{erf [ a / ( {2}^{1 / 2} {σ}_{M} ) ]}{\sqrt{a}} . \qquad ( 65 )$$

The function f(x)=erf(x)/\sqrt{x} has its maximum, 0.8427, at x=0.99. By choosing a=2^{1/2}σ_{M} for the calculation of the SNR we then obtain

SNR=0.05639\sqrt{L_{y}Sᵢₙr_{sys}⁻¹}λ|φ|ₘₐₓ|r′_{sys}|σ_{M}^{-1/2}. (66)

Analysis of eq. (66) shows that the SNR depends on the following three groups of parameters: 1) the parameters of the incident beam (wavelength and flux); 2) object characteristics (maximum phase shift and width of the phase edge); and 3) geometrical parameters of the imaging system (gratings periods, source size and detector resolution). In the following we shall assume that the incident flux is fixed (this can be achieved by choosing a proper acquisition time of the image). Then the SNR can be presented as follow,

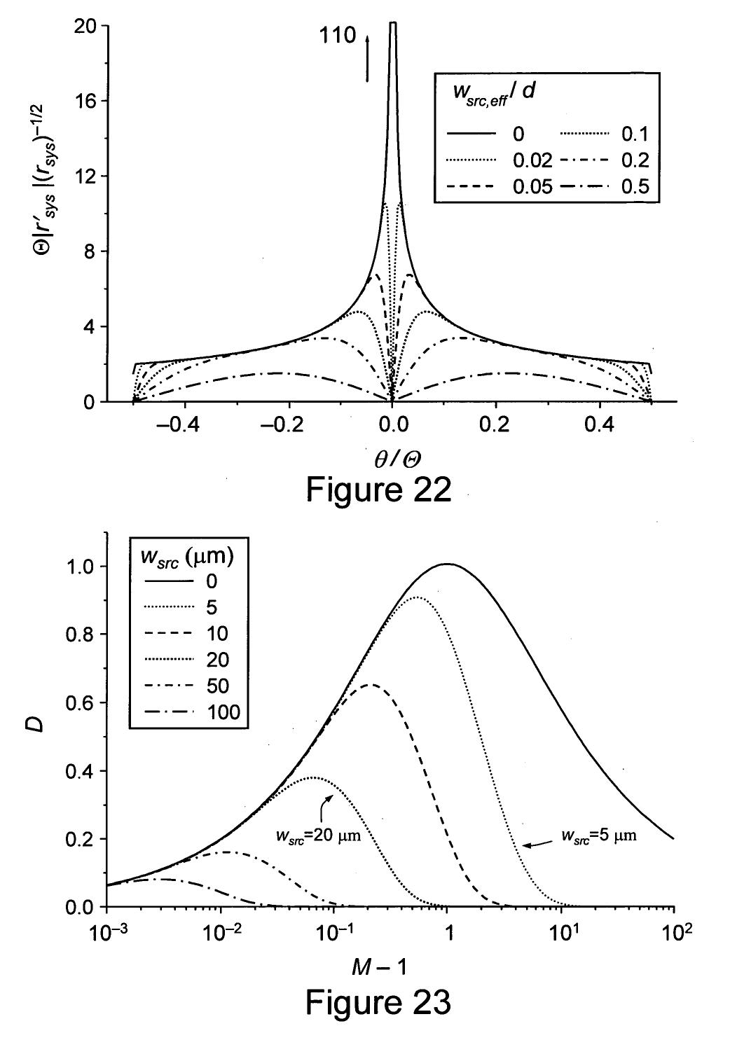

SNR=Cλ|φ|_{max(|}r′_{sys}|r_{sys}^{-1/2})σ_{M}^{-1/2}, (67)

where C=0.05639 \sqrt{L_{y} Sᵢₙ} is a constant. The function Θ|r′_{sys}|r_{sys}^{-1/2} depends on both the working point, θ/Θ, defined by the relative shift of the gratings, and on the source size, w_{src,eff}/d. FIG. 22 shows the dependences of this function on θ/Θ for different values of the ratio W_{src,eff}/d. As follows from FIG. 22, for each value of this ratio, there is an optimum value of θ/Θ which maximises the function Θ|r′_{sys}|r_{sys}^{-1/2}. This optimum value of θ/Θ is close to zero for small sources and increases with the source size, approaching ±¼ for large source size. While choosing the working point, θ/Θ, one should also take into account that the GOA is better satisfied at the linear slopes of the system function, i.e. in the vicinity of θ/Θ=±¼. In the following we shall concentrate on the optimisation of the geometrical parameters of the imaging system, assuming that the working point is fixed to Θ/Θ=±¼. This choice of the working point guarantees constant value of the function Θ|r′_{sys}|r_{sys}^{-1/2} for small sources (w_{src,eff}/d≦0.2) and almost maximum value of this function for larger source sizes (w_{src,eff}/d>0.2).

Assuming θ/Θ=±¼ (so that r_{sys}=½), a point source (w_{src}=0) and an ideal detector (σ_{det}=0), the SNR of this idealised system is equal to

$${SNR}^{id} = C λ {\vert ϕ \vert}_{ma x} \frac{2 \sqrt{2}}{{Θσ}_{obj}^{1 / 2}} . \qquad ( 68 )$$

According to this last equation, the SNR^{id} is proportional to the maximum phase shift and inversely proportional to the square root of the object size. If the maximum phase shift is fixed but the object size is varying (for example, the edge of the same height but with different smearing), the maximum achievable SNR decreases with the object size increase, as (σ_{obj})^{-1/2}. However, if the phase shift is proportional to the object size, the maximum achievable SNR increases with the object size, as (σ_{obj})^{1/2}. The SNR^{id} increases with the total distance as R^{1/2} as well as with the X-ray wavelength, approximately as λ^{3/2}. It is assumed that both the R and λ are independent parameters of the system, while the period of the second grating is calculated according to the following equation,

d₂=\sqrt{2λR(M−1)/m}. (69)

The period of the system function, Θ, can be expressed in terms of the total source-to-detector distance, R, X-ray wavelength, λ, and magnification of the system, M, as follows

$$Θ {=}^{Δ} \frac{d}{{R}^{′}} = \frac{2 λ M}{{md}_{2 }} = \sqrt{\frac{2 λ}{mR}} \frac{M}{\sqrt{M - 1}} . \qquad ( 70 )$$

Equation (70) indicates that given fixed values of X and R, the system period can only change with magnification. In particular, it increases to infinity for both large magnifications and magnifications close to one and there is a minimum at M=2. Therefore the maximum of the SNR^{id} is achieved at M=2, SNRₘₐₓ^{id}=SNR^{id}(M=2).

Maximisation of the SNR in terms of the system magnification, M, in the case of a non-ideal imaging system, σ_{src}≠0 and/or σ_{det}≠0, results in maximisation of the following expression,

$$SNR = {SNR}_{ma x}^{id} \frac{( 1 / 2 ) {Θ}_{ma x} \vert {r}_{sys}^{′} \vert}{\sqrt[4]{1 + {{M}^{- 2} ( {σ}_{det} / {σ}_{obj} )}^{2}}} , \qquad ( 71 )$$

where Θₘₐₓ=Θ|_{M=2}=\sqrt{8λ/(mR)}. The system function derivative can be presented using the Fourier series as

$${r}_{sys}^{′} ( θ ) = 8 / ( π Θ ) {\sum }_{k = 0}^{∞} {( 2 k + 1 )}^{- 1} sin [ 2 π ( 2 k + 1 ) θ / Θ ] {\hat{S}}_{src , eff} [ ( 2 k + 1 ) / d ] . \qquad ( 72 )$$

Analysis of eq. (72) shows that at the fixed working point of the system, θ/Θ=±¼, the derivative of the system function depends on the system magnification via the effective source size in the object plane, w_{src,eff}=(1−M⁻¹) w_{src}, the period of the Talbot self image, d=d₂/M=M⁻¹\sqrt{2λR(M−1)/m} and the period of the system function, Θ (see eq. (70)). The ratio w_{src,eff}/d can be presented via the independent parameters of the system, M, m, w_{src}, λ and R, as follows

w_{src,eff}/d=\sqrt{(M−1)m/2}(w_{src}/\sqrt{λR}). (73)

We now introduce a damping function,

$$D {=}^{Δ} SNR / {SNR}_{ma x}^{id} = \frac{( 1 / 2 ) {Θ}_{ma x} \vert {r}_{sys}^{′} \vert}{\sqrt[4]{1 + {{M}^{- 2} ( {σ}_{det} / {σ}_{obj} )}^{2}}} \\ = \frac{\sqrt{M - 1 } Θ \vert {r}_{sys}^{′} \vert}{M \sqrt[4]{1 + {{M}^{- 2} ( {σ}_{det} / {σ}_{obj} )}^{2}}} . \qquad ( 74 )$$

This function characterises the degree of degradation of the SNR in the image obtained using a real imaging system compared to the maximum achievable SNR in the image obtained using an ideal imaging system (with a point source and an ideal detector). The goal is to find such magnification of the imaging system, Mₒₚₜ, which maximises the damping function at given values of the parameters p_{det}=σ_{det}/σ_{obj} and q_{src}=w_{xrc}/(λR)^{1/2} (λ and R are assumed to be fixed). This optimum magnification is obtained as the trade-off between the three competing tendencies: the finite-source-size, induced degradation of the system function, the factor Θ|r′_{sys}| in eq. (74), which worsens with magnification (see FIG. 23), the finite detector resolution which is described by the forth order root in eq. (74) and which reduces to 1 at large magnifications, and the sensitivity of the imaging system, described by the factor (M−1)^{1/2}/M in eq. (74), which has its maximum at M=2.

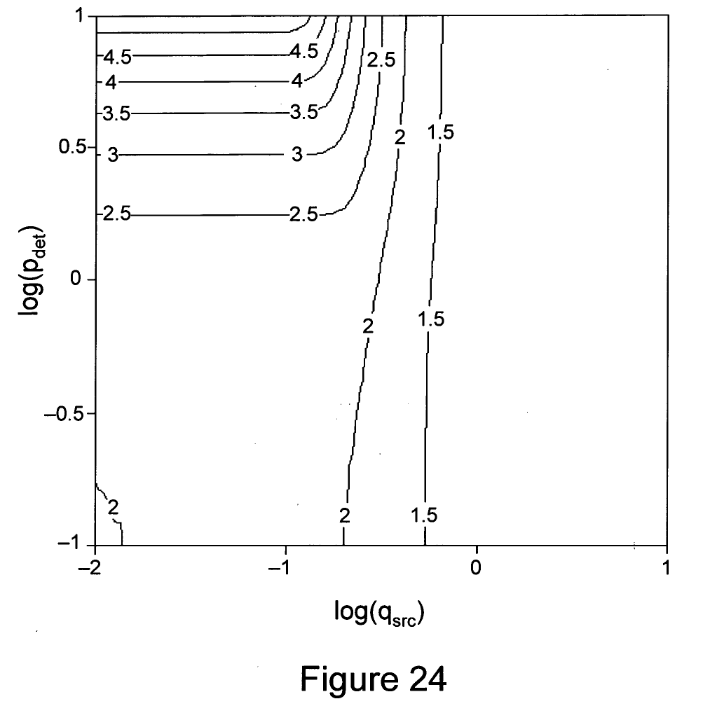

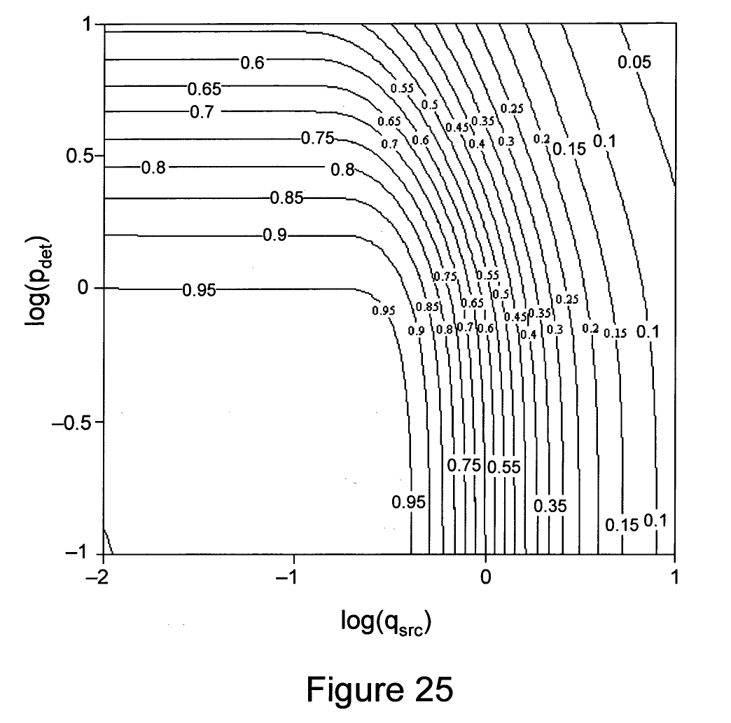

FIG. 24 shows the dependence of the optimum magnification on the two dimensionless parameters, q_{src} and p_{det}, obtained by numerical optimisation of the damping function, examples of which are presented in FIG. 23. FIG. 25 shows the corresponding maximum values of the damping function.

In order to give some quantitative insight into the performance of a real imaging system, consider the following parameters of the system and phase edge: source size w_{src}=5 μm, maximum phase shift |φ|ₘₐₓ=100 radians at X-ray wavelength λ=0.5 Å, s.d. of the edge smearing σ_{obj}=100 μm, s.d. of the detector resolution σ_{det}=10 μm, and total source-to-detector distance R=2 m. The corresponding parameters of the damping function are q_{src}=5/(0.5×10⁻⁴×2×10⁶)^{1/2}=0.5, p_{det}=10/100=0.1. Using these values the maximum value of the damping function, Dₘₐₓ=0.909, is achieved at the optimum magnification Mₒₚₜ=1.544. The ratio w_{src,eff}/d takes the following value, w_{src,eff}/d=[(Mₒₚₜ−1)/2]^{1/2} q_{src}=0.26 which is close to that (0.3) above which the system function can be approximated by a sine function. The corresponding period of the second grating is d₂=[2λR(M−1)/m]^{1/2}=(2×100×0.544)^{1/2} μm=10.43 μm, and the period of the system function is Θ=2λM/(md₂)=10⁻⁴×1.544/10.43≈14.8 μrad (≈3.05″). For comparison, Θₘₐₓ=[8λ/(mR)]^{1/2}≈14.14 μrad (≈2.92″).

The maximum achievable value of the SNR,

$${SNR}_{ma x}^{id} = C λ {\vert ϕ \vert}_{ma x} \frac{2 \sqrt{2}}{{Θ}_{ma x} {σ}_{obj}^{1 / 2}}$$

$$( where C = 0.05639 \sqrt{{L}_{y} {S}_{i n} } )$$

can also be estimated. Assuming, for example, that L_{y}=1 mm, Sᵢₙ=1 ph/μm² (so that about 100 photons are collected in each detector pixel), one obtains, SNRₘₐₓ^{id}≈178 (which is an integral signal-to-noise, corresponding to about 154 pixels along the edge). The maximum refraction angle due to the object is βₘₐₓ=k⁻¹|φ′|ₘₐₓ=k⁻¹|φ|ₘₐₓ/[(2π)^{1/2}σ_{obj}]≈3 μrad. It is also informative to calculate the following quantity, N⁻¹=k⁻¹R′|φ″|ₘₐₓ, which should be much smaller compared to one so that the effect of the free space propagation can be neglected and validity of the GOA be satisfied. It is useful to rewrite this number in the alternative form:

N⁻¹=d|β′|ₘₐₓ/Θ=(d₂/M)|β′|ₘₐₓ/Θ.

The maximum value of the refraction angle derivative is |β′|ₘₐₓ=βₘₐₓ e^{-1/2}/σ_{obj}. As a result, one obtains N⁻¹≈0.009.

The parameters of the system, calculated above, are summarised in the second row of Table 8, which also contains parameters of the system for other values of the source size, including the case of an ideal system (in the first row). For, comparison, the second line in each row contains parameters of the system corresponding to a non-optimum magnification M=1.02. This value was chosen based entirely on the practical considerations, as this magnification gives a reasonable compromise between the performance of the system and its physical size (distance between the gratings and their periods).

In the case of a macro-focus source, the effective size of the source, w_{src,eff}, in the chosen imaging geometry is significantly larger than the period of the self-image of the first grating, d. In order to avoid excessive smearing of the system function, r_{sys}, an additional amplitude grating, G₀, is provided in front of the macro-focus source (cf. grating 42 of FIG. 3). The period, d₀, of this grating is calculated according to the formula,

d₀=(R₁/R₂)d₂=d₂/(M−1). (75)

Each of the sourcelets, generated by grating G₀, creates its own image of the object. The images (backprojected onto the object plane) created by the adjacent sourcelets are shifted with respect to each other by the distance d₀ (1−M⁻¹), which results, in additional smearing relative to the ideal image obtained using a single sourcelet. If the number of the sourcelets is large then the smearing of the ideal image can be approximated by a convolution of the ideal image with the (properly normalised) intensity distribution of the source and the optimum parameters of the imaging system can be found by maximising the SNR defined by eq. (66), where σ_{sys} is now generalised as

TABLE 8
System parameters at the X-ray wavelength
λ = 0.5 Å and the total source-to-detector distance
R = 2 m. The s.d. of the edge smearing is fixed,
σ_{obj} = 100 μm. σ_{det} is the s.d. of the detector
resolution.

| w_{src} (μm) | σ_{det} | Mₒₚₜ | Dₘₐₓ | M | D | w_{src,eff}/d | d₂ (μm) | Θ (μrad) | R₂ (mm) | z₁ (mm) | N⁻¹ (×10⁴) |
|---|---|---|---|---|---|---|---|---|---|---|---|
| 0 | 0 | 2 | 1 | 2 | 1 | 0 | 14.1 | 14.1 | 1000 | 500 | 96 |
| | | | | 1.02 | 0.279 | 0 | 2.0 | 51.0 | 39 | 38 | 7.4 |
| 5 | 10 | 1.544 | 0.909 | 1.544 | 0.909 | 0.26 | 10.4 | 14.8 | 705 | 456 | 88 |
| | | | | 1.02 | 0.277 | 0.05 | 2.0 | 51.0 | 39 | 38 | 7.4 |
| 10 | 10 | 1.212 | 0.651 | 1.212 | 0.651 | 0.33 | 6.5 | 18.6 | 349 | 288 | 55 |
| | | | | 1.02 | 0.277 | 0.1 | 2.0 | 51.0 | 39 | 38 | 7.4 |
| 20 | 10 | 1.066 | 0.380 | 1.066 | 0.380 | 0.36 | 3.6 | 29.4 | 123 | 116 | 22 |
| | | | | 1.02 | 0.275 | 0.2 | 2.0 | 51.0 | 39 | 38 | 7.4 |
| 50 | 10 | 1.011 | 0.161 | 1.011 | 0.161 | 0.375 | 1.5 | 67.5 | 0.022 | 0.022 | 4.4 |
| | | | | 1.02 | 0.145 | 0.5 | 2.0 | 51.0 | 0.039 | 0.038 | 7.4 |
| 100 | 10 | 1.003 | 0.081 | 1.003 | 0.081 | 0.394 | 0.8 | 127.3 | 0.006 | 0.006 | 1.1 |
| | | | | 1.02 | 0.01 | 1.0 | 2.0 | 51.0 | 0.039 | 0.038 | 7.4 |

σ_{sys}²(M)=(1−M⁻¹)²σ_{src}²+M⁻²σ_{det}², (76)

where σ_{src} is the s.d. of the intensity distribution of the source. The width of the sourcelets is hereafter denoted by A_{src} (a rectangular profile is assumed in grating G₀). Designating, as above, SNR^{id}ₘₐₓ the maximum achievable SNR for an ideal system (with point source and ideal detector), the SNR for a non-ideal system is expressed as SNR=D SNRₘₐₓ^{id} where the damping function is given by a slightly modified version of eq. (74),

$$D = \frac{\sqrt{M - 1} Θ \vert {r}_{sys}^{′} \vert}{M \sqrt[4]{\begin{matrix}1 + {( 1 - {M}^{- 1} )}^{2} {( {σ}_{src} / {σ}_{obj} )}^{2} + \\ {{M}^{- 2} ( {σ}_{det} / {σ}_{obj} )}^{2}\end{matrix}}} . \qquad ( 77 )$$

The system function derivative in eq. (77) is defined by eq. (72) in which the Fourier transform of the (rectangular) sourcelet intensity distribution of width A_{src} is

Ŝ_{src,eff}(u)=sin c(πA_{src,eff}u), (78)

where A_{src,eff}=(1−M⁻¹) A_{src}.

The source now affects the SNR in two ways, firstly as above via the finite size of each individual sourcelet, A_{src}, and secondly, via the s.d. of the entire source, σ_{src}.

Thus when optimising the imaging setup (i.e. maximising the damping function, D), an additional parameter, p_{src}=σ_{src}/σ_{obj}, is taken into account.

The above theoretical analysis is supported by the following numerical results. Consider the same parameters of the object and detector as employed above: maximum phase shift |φ|ₘₐₓ=100 radians at X-ray wavelength λ=0.5 Å, s.d. of the edge smearing σ_{obj}=100 μm, s.d. of the detector resolution σ_{det}=10 μm, and total source-to-detector distance R=2 m. The source is now defined by two parameters: the sourcelet size A_{src}=5 μm (the space in the amplitude grating G₀) and the s.d. of the Gaussian source σ_{src}=500 μm. The corresponding parameters for the damping function are q_{src}=5/(0.5×10⁻⁴×2×10⁶)^{1/2}=0.5, p_{det}=10/100=0.1 and p_{src}=500/100=5. The corresponding optimum parameters of the system are summarised in the first line of Table 9. Table 9 also contains the system parameters calculated for the larger sourcelet sizes: 10, 20 and 50 μm. Increasing the sourcelet size, the optimum magnification and the corresponding SNR and period of the second grating gradually decrease. Also, the distance between the gratings, R₂, decreases from about 0.54 m for the 5 micron sourcelet size to about 0.04 m for the 50 micron sourcelet size. The last column in Table 9 indicates that the GOA is better satisfied when increasing the sourcelet size.

TABLE 9
System parameters at the X-ray wavelength
λ = 0.5 Å and the total source-to-detector distance
R = 2 m. The s.d. of the edge smearing is fixed,
σ_{obj} = 100 μm; σ_{det} = 10 μm is the s.d. of the detector
resolution, σ_{src} = 500 μm is the s.d. of the source
intensity distribution and A_{src} is the space width of
the zeroth grating (sourcelet size).

| A_{src} (μm) | Mₒₚₜ | Dₘₐₓ | M | D | A_{src,eff}/d | d₂ (μm) | Θ (μrad) | R₂ (mm) | z_{1 (mm)} | d₀ (μm) | w_{src}/d₀ | N⁻¹ (×10⁴⁾ |
|---|---|---|---|---|---|---|---|---|---|---|---|---|
| 5 | 1.368 | 0.685 | 1.368 | 0.685 | 0.2145 | 8.6 | 15.9 | 538 | 393 | 23.3 | 50.5 | 76 |
| | | | 1.02 | 0.276 | 0.05 | 2.0 | 51.0 | 39 | 38 | 100 | 11.8 | 7.4 |
| 10 | 1.351 | 0.685 | 1.351 | 0.685 | 0.419 | 8.4 | 16.1 | 520 | 385 | 23.9 | 49.3 | 74 |
| | | | 1.02 | 0.276 | 0.1 | 2.0 | 51.0 | 39 | 38 | 100 | 11.8 | 7.4 |
| 20 | 1.124 | 0.585 | 1.124 | 0.585 | 0.498 | 5.0 | 22.6 | 220 | 196 | 40.2 | 29.3 | 38 |
| | | | 1.02 | 0.276 | 0.2 | 2.0 | 51.0 | 39 | 38 | 100 | 11.8 | 7.4 |
| 50 | 1.02 | 0.275 | 1.02 | 0.275 | 0.5 | 2.0 | 51.0 | 39 | 38 | 100 | 11.8 | 7.4 |
| | | | 1.02 | 0.275 | 0.5 | 2.0 | 51.0 | 39 | 38 | 100 | 11.8 | 7.4 |

It should also be noted that the fraction of the source area contributing to the image formation increases with the sourcelet size. For example, this fraction is only 5/23.3=21.5% in the case of the 5 μm sourcelet and asymptotically approaches 50% with increasing the sourcelet size. This parameter (the open source area fraction) together with other parameters of the system (like magnification, source-to-detector distance etc.) defines the incident flux in the object plane and, as a result, the image acquisition time.

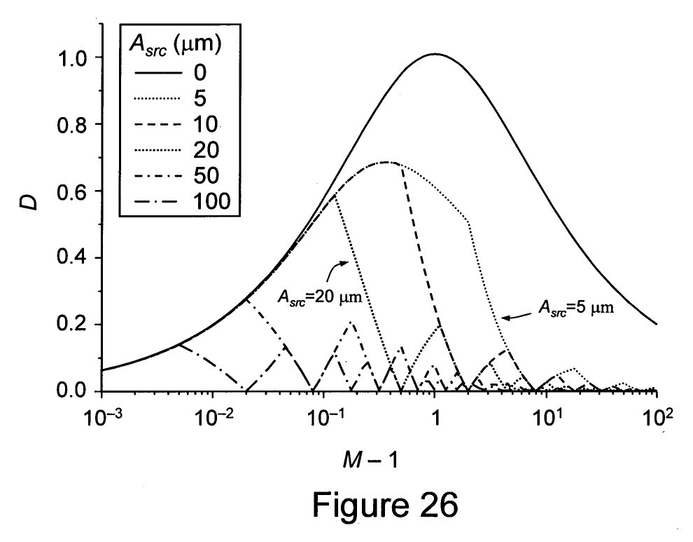

The dependences of the damping function on magnification for several different values of the size of the uniform (rectangular) source, used in our numerical calculations, are shown in FIG. 26. It should be noted that unlike the case of the Gaussian source (cf. FIG. 23), the damping functions in FIG. 26 have multiple local maxima (for a non-zero source size). This is due to a more complicated behaviour of the system function with the uniform source size. Namely, keeping all other parameters of the system fixed, the system function oscillates periodically as a function of the source size.

It is also possible to employ other phase/amplitude retrieval methods with the scanning double-grating (SDG) imaging system of the present invention. According to the above theoretical analysis, the spectral density of the X-ray wavefield in the detector plane may be written as:

M²S_{det}(Mx,My,λ;Δx)=∫∫∫∫dXdX′dYdY′T_{sys}(X,Y,X′,Y′;λ,Δx)Q(x−X,y−Y,λ)×Q*(x−X′,y−Y′,λ), (79)

where the propagation function T_{sys} of the system has been introduced, where

T_{sys}(x,y,x′,y′;λ,Δx)≡gᵢₙ(x′−x,y′−y,λ)P_{R′}(x,y;λ)P*_{R′}(x′,y′;λ)G(x−Δx,x′−Δx;λ), (80)

and the function G(x, x′; λ) is defined as

G(x,x′;λ)≡d₁⁻¹∫₀^{d}^{₁}dXt₁(X−x;λ)t*₁(X−x′;λ)T₂(MX;λ). (81)

Here t₁ is the complex transmission function of the first grating and T₂ is the real transmittance function of the second (amplitude) grating, d₁ is the period of the first grating. A modified transmission function Q≡Sᵢₙ^{1/2}×exp(iφᵢₙ)_{q} has been introduced in eq. (79), where Sᵢₙ (x, y, λ) and φᵢₙ(x, y, λ) are the spectral density and the phase distribution in the wavefield incident onto the object; q(x, y, λ) is the complex transmission function of the object. P_{R′} denotes the free-space propagator and gᵢₙ is the spectral degree of coherence in the incident wavefield.

In a geometrical optics approximation, if it is assumed that the transmission function Q is slowly varying compared to the system propagation function T_{sys}. Then applying the stationary-phase method [23] to the integral in eq. (79), preserving only the first two terms in the corresponding decomposition formula and neglecting the diffraction effects due to the intensity variations in the object wave, one obtains the geometrical-optics approximation (GOA) for the spectral density in the detector plane:

M²S_{det}(Mx,My,λ;Δx)≅S₀(x,y,λ)[1−k⁻¹R′∇²φ(x,y,λ)]\hat{T}_{sys}(u₀,u₀,−u₀,−u₀;λ,Δx), (82)

where S₀≡|Q|²=Sᵢₙ|q|², φ≡arg(Q) and u₀≡−(2π)⁻¹∂ₓφ(x, y, λ).

In a weak-object approximation, if it is assumed that the wavefield in the exit plane of the object (the object plane) has small variations of its spectral density across the whole field of view,

|S₀(x,y,λ)− S̅₀(λ)|<< S̅₀(λ),∀(x,y),∀λ, (83)

and the phase of the wavefield in the object plane is satisfying the condition

|φ(x,y,λ)−φ(x′,y′,λ)|<<1,∀x,y,x′,y′:|x−x′|≦Lₓ,|y−y′|≦L_{y}, (84)

where Lₓ and L_{y} are characteristic length scales of the system propagation function along the x-axis and y-axis respectively. Analysis of eq. (80) allows one to distinguish two characteristic length scales in the direction of y-axis and three characteristic length scales along the x-axis. The first pair of the length scales originates from the spectral degree of coherence which is characterized by the spatial coherence lengths in the two orthogonal directions, l_{coh,x} and l_{coh,y} respectively. The second length scale originates from the isotropic free-space propagator which is characterized by the corresponding radius of the first Fresnel zone, (λR′)^{1/2}. The third length scale appears specifically along the x-axis due to the periodical modulation caused by the gratings; this is the period d of the self image (referred to the object plane). The smallest of these length scales in each direction should be used for Lₓ and L_{y} in eq. (84).

It is convenient to present the spectral density function in the object plane as follows:

S₀(x, y, λ)= S̅₀(λ)exp[−2B(x, y, λ)], so that eq. (83) may be equivalently written as

|B(x,y,λ)|<<1,∀(x,y),∀λ. (85)

Using eqs. (84) and (85) the product of two transmission functions in Eq. (79) can be well approximated by the first two terms of the Taylor decomposition applied to the exponent function,

Q(x−X,y−Y,λ)Q*(x−X′,y−Y′,λ)≅ S̅₀(λ){1+i[φ(x−X,y−Y,λ)−φ(x−X′,y−Y′,λ)]−B(x−X,y−Y,−B(x−X′,y−Y′,λ)}. (86)

Substituting eq. (84) into eq. (79) and taking the Fourier transform of both sides of the resultant equation, one obtains the following expression

Ŝ_{det}(u/M,v/M,λ;Δx)/ S̅₀(λ)≅\hat{T}_{sys}(0,0,0,0;λ,Δx)δ(u)δ(v)+i\hat{φ}(u,v,λ)[\hat{T}_{sys}(u,v,0,0;λ,Δx)−\hat{T}*_{sys}(−u,−v,0,0;λ,Δx)]−\hat{B}(u,v,λ)[\hat{T}_{sys}(u,v,0,0;λ,Δx)+\hat{T}*_{sys}(−u,−v,0,0;λ,Δx)]. (87)

In deriving eq. (87) the following property of the system propagation function is used:

T_{sys}(x,y,x′,y′;λ,Δx)=T*_{sys}(x′,y′,x,y;λ,Δx), (88)

which results in

\hat{T}_{sys}(u,v,u′,v′;λ,Δx)=\hat{T}*_{sys}(−u′,−v′,−u,−v;λ,Δx). (89)

### Diffraction-Enhanced Imaging Analogue for SDG Imaging

Diffraction-Enhanced Imaging (DEI) is a method for analyzing image data obtained via an analyzer-crystal-based imaging system with the aim of simultaneously extracting amplitude (absorption) and phase-gradient (refraction-angle) information using two images collected at the opposite slopes of the analyzer-crystal rocking curve [7].

In order to apply some aspects of analyzer-based imaging (and in particular DEI) to SDG, it is convenient to introduce the system function

r_{sys}[(Δx/R′);λ]≡\hat{T}_{sys}(0,0,0,0;λ,Δx).

This system function is an analogue of the rocking curve of the crystal-analyser in ABI. The ratio Δx/R′ defines the working point on the SDG system function (which is periodical with an angular period d/R′) while the product −λu₀ is a deflection angle induced by the object and other imperfections of the imaging system upstream of the gratings. Let an image be collected using the SDG imaging system with the working point located at the linear slopes of the system function. Assuming that the deflection angles are small compared to the angular period of the system function, eq. (82) can be rewritten in the following form:

$${M}^{2} {S}_{det} ( M x , M y , λ ; Δ x ) \approx {S}_{0} ( x , y , λ ) [ 1 - {k}^{- 1} {R}^{′} {∇}^{2} ϕ ( x , y , λ ) ] \times [ \begin{matrix}{r}_{sys} ( Δ x / {R}^{′} ; λ ) + \\ λ {u}_{0} {r}_{sys}^{′} ( Δ x / {R}^{′} ; λ )\end{matrix} ] = {S}_{0} ( x , y , λ ) {r}_{sys} ( Δ x / {R}^{′} ; λ ) [ 1 - {k}^{- 1} {R}^{′} {∇}^{2} ϕ ( x , y , λ ) ] \times [ 1 + λ {u}_{0} ( {r}_{sys}^{′} / {r}_{sys} ) ( Δ x / {R}^{′} ; λ ) ] \approx {S}_{0} ( x , y , λ ) {r}_{sys} ( Δ x / {R}^{′} ; λ ) \times [ \begin{matrix}1 + λ {u}_{0} ( {r}_{sys}^{′} / {r}_{sys} ) ( Δ x / {R}^{′} ; λ ) - \\ {k}^{- 1} {R}^{′} {∇}^{2} ϕ ( x , y , λ )\end{matrix} ] ,$$

and, introducing the corresponding flat-field (i.e. without object) image spectral density, (S_{det})^{FF}(x, y, λ; Δx), one can rewrite the previous equation as:

S_{det}(Mx,My,λ;Δx)≈(S_{det})^{FF}(Mx,My,λ;Δx)|q(x,y,λ)|²×[1−k⁻¹∂ₓφ(x,y,λ)(r′_{sys}/r_{sys})(Δx/R′;λ)−k⁻¹R′∇²φ(x,y,λ)]. (90)

Eq. (90) can be further simplified if one considers a weakly absorbing object, such that |q(x, y, λ)|²=exp[−2B_{obj}(x, y, λ)]≈1−2B_{obj}(x, y, λ), and eq. (90) takes the form:

S_{det}(Mx,My,λ;Δx)≈(S_{det})^{FF}(Mx,My,λ;Δx)×[1−2B_{obj}(x,y,λ)−k⁻¹∂ₓφ(x,y,λ)(r′_{sys}/r_{sys})(Δx/R′;λ)−k⁻¹R′∇²φ(x,y,λ)].

The intensity distribution in the detector is obtained by integrating the previous equation over the X-ray wavelength:

I_{det}(Mx,My;Δx)≈∫dλ(S_{det})^{FF}(Mx,My,λ;Δx)×[1−2B_{obj}(x,y,λ)−k⁻¹∂ₓφ(x,y,λ)(r′_{sys}/r_{sys})(Δx/R′;λ)−k⁻¹R′∇²φ(x,y,λ)].

Assuming also that the spectral density of the incident wavefield can be factorised into a pure spectral distribution and a pure spatial distribution, that is Sᵢₙ(x, y, λ)=S_{in,spec}(λ)×S_{in,spat}(x, y), the flat field image, (I_{det})^{FF}(x, y; Δx), can be represented as

$$\begin{matrix}{{M}^{2} ( {I}_{det} )}^{FF} ( M x , M y ; Δ x ) = {S}_{i n , spat} ( x , y ) \times \int d λ {S}_{i n , spec} ( λ ) \\ {r}_{sys} ( Δ x / {R}^{′} ; λ ) \\ = {S}_{i n , spat} ( x , y ) {r}_{sys} ( Δ x / {R}^{′} ) ,\end{matrix}$$

and the previous equation then transforms to

$${I}_{det} ( M x , My ; Δ x ) \approx {M}^{- 2} {S}_{i n , spat} ( x , y ) \int d λ {S}_{i n , spec} ( λ ) {r}_{sys} ( Δ x / {R}^{′} ; λ ) \times [ \begin{matrix}\begin{matrix}1 - 2 {B}_{obj} ( x , y , λ ) - {k}^{- 1} {\partial }_{x} ϕ ( x , y , λ ) \\ ( {r}_{sys}^{′} / {r}_{sys} ) ( Δ x / {R}^{′} ; λ ) -\end{matrix} \\ {k}^{- 1} {R}^{′} {∇}^{2} ϕ ( x , y , λ )\end{matrix} ] = {( {I}_{det} )}^{FF} ( M x , My ; Δ x ) {r}_{sys}^{- 1} ( Δ x / {R}^{′} ) \int d λ {S}_{i n , spec} ( λ ) {r}_{sys} ( Δ x / {R}^{′} ; λ ) \times [ \begin{matrix}\begin{matrix}1 - 2 {B}_{obj} ( x , y , λ ) - \\ {k}^{- 1} {\partial }_{x} ϕ ( x , y , λ ) ( {r}_{sys}^{′} / {r}_{sys} ) ( Δ x / {R}^{′} ; λ ) -\end{matrix} \\ {k}^{- 1} {R}^{′} {∇}^{2} ϕ ( x , y , λ )\end{matrix} ] .$$

Finally one has:

I^{det}(Mx,My;Δx)/(I_{det})^{FF}(Mx,My;Δx)−1≈r_{sys}⁻¹(Δx/R′)·dλS_{in,spec}(λ)r_{sys}(Δx/R′;λ)×[2B_{obj}(x,y,λ)+k⁻¹∂ₓφ(x,y,λ)(r′_{sys}/r_{sys})(Δx/R′;λ)+k⁻¹R′∇²φ(x,y,λ)].

Collecting two images, I_{det}(x, y; Δx₁) and I_{det}(x, y; Δx₂) corresponding to the working points Δx₁ and Δx₂, located symmetrically on the opposite slopes of the SDG system function (so that r_{sys}(Δx₁/R′; λ)=r_{sys} (Δx₂/R′; λ) VA), as well as the corresponding flat-field images, (I_{det})^{FF}(x, y; Δx₁) and (I_{det})^{FF}(x, y; Δx₂), the phase-derivative information can be extracted with the expression:

I_{det}/(I_{det})^{FF}(Mx,My;Δx₁)−I_{det}(I_{det})^{FF}(Mx,My;Δx₂)≈∓2r_{sys}⁻¹(Δx_{1,2}/R′)∫dλS_{in,spec}(λ)k⁻¹∂ₓφ(x,y,λ)r′_{sys}(λx_{1,2}/R′;λ), (91)

as can the propagation-based contrast, with the expression:

I_{det}/(I_{det})^{FF}(Mx,My;Δx₁)+I_{det}/(I_{det})^{FF}(Mx,My;Δx₂)≈2−2r_{sys}⁻¹(Δx_{1,2}/R′)∫dλS_{in,spec}(λ)r_{sys}(Δx_{1,2}/R′;λ)×[2B_{obj}(x,y,λ)+k⁻¹R′∇²φ(x,y,λ)]. (92)

### Multi-Image Phase and Amplitude Retrieval

If it is assumed that the spectrum of the incident beam is narrow, so that Δλ/λ<0.1, and is far from the absorption edges of the materials constituting the object and the gratings. Then introducing the refraction angle, α(x,y;λ)≡−λu₀(x,y;λ)=k⁻¹∂ₓφ(x,y;λ), and the absorption function of the object, B(x,y;λ)≡−(½) ln(|q(x,y;λ)|²), both the refraction angle and the absorption function can be well approximated using the following linear decompositions,

α(x,y;λ)≅α(x,y;λ₀)(1+2ε),

B(x,y;λ)≈B(x,y;λ₀)[1+k(x,y)ε], (93)

where ε≡λ/λ₀−1<0.1, λ₀ is some ‘central’ value of the wavelength (see below for the derivation of a more precise definition for λ₀), and k(x,y) is the slope coefficient of the absorption function for a point (x,y) in the object plane (whose value depends on the chemical composition of the object's voxels contributing to the absorption at this point of the object plane).

Assuming further that the refraction angles do not exceed a period, d/R′, of the of the system function r_{sys}(θ) and that the absorption function of the object does not exceed one, the product 2ε α(x,y;λ₀) is small compared to the period of the system function and the product 2ε B(x,y;λ₀) k(x,y) is small compared to one. This allows one to present the right-hand-side of eq. (93), the transmission function of the object, exp[−2B(x,y;λ)], and the eikonal of the object wave, k⁻¹φ(x,y;λ), as follows (with θ₀≡Δx/R′):

r_{sys}[θ₀−α(x,y;λ);λ]≅r_{sys}[θ₀−α(x,y;λ₀);λ]−2εα(x,y;λ₀)r′_{sys}[θ₀−α(x,y;λ₀);λ], (94)

exp[−2B(x,y;λ)]≅exp[−2B(x,y;λ₀)][1−2B(x,y;λ₀)k(x,y)ε], (95)

k⁻¹φ(x,y;λ)≅k₀⁻¹φ(x,y;λ₀)(1+2ε). (96)

Substituting eqs. (94) to (96) into eq. (82) one obtains

M²S_{det}(Mx,My,λ;Δx)≅Sᵢₙ(x,y,λ)exp[−2B(x,y;λ₀)][1−2εk(x,y)B(x,y;λ₀)]×[1−k₀⁻¹R′(1+2ε)∇²φ(x,y;λ₀)]×{r_{sys}[θ₀−α(x,y;λ₀);λ]−2εα(x,y;λ₀)r′_{sys}[θ₀−α(x,y;λ₀);λ]}

It is convenient to group the terms in the previous equation as follows:

M²S_{det}(Mx,My,λ;Δx)≅Sᵢₙ(x,y,λ)exp[−2B(x,y;λ₀)]×{r_{sys}(θ;λ)(1−k₀⁻¹R′∇²φ)+2ε[−αr′_{sys}(θ;λ)−k₀⁻¹R′∇²φr_{sys}(θ;λ)−kBr_{sys}(θ;λ)+αr′_{sys}(θ;λ)k₀⁻¹R′∇²φ+kBr_{sys}(θ;λ)k₀⁻¹R′∇²φ]+4ε²k₀⁻¹R′∇²φ[αr′_{sys}(θ;λ)+kBr_{sys}(θ;λ)+kBαr′_{sys}(θ;λ)]−8ε³kBk₀⁻¹R′∇²φαr_{sys}(θ;λ)}. (97)

Eq. (97) was obtained assuming narrow energy spread in the incident beam, |ε|≦0.1. As a result one can neglect all terms proportional to ε² and ε³. Also, in eq. (97) the terms proportional to ε are written in the descending order of their magnitude and the last two terms can be neglected as these are an order of magnitude smaller than the first three terms. As a result one has

M²S_{det}(Mx,My,λ;Δx)≅Sᵢₙ(x,y,λ)exp[−2B(x,y;λ₀)]{r_{sys}(θ;λ)(1−k₀⁻¹R′∇²φ)+2ε[−αr_{sys}(θ;λ)−k₀⁻¹R′∇²φr_{sys}(θ;λ)−kBr_{sys}(θ;λ)]}. (98)

Integrating eq. (98) over wavelength, one obtains the following approximate expression for the intensity distribution in the detector plane (assuming, for simplicity, that the incident spectral density can be factorised into spatial and spectral terms, viz. Sᵢₙ(x, y;λ)=S_{in,spat}(x, y) S_{in,spec}(λ)):

M²I_{det}(Mx,My;Δx)≅S_{in,spat}(x,y)exp[−2B(x,y;λ₀)]{r_{sys,poly}(θ)(1−k₀⁻¹R′∇²φ)+2∫dλS_{in,spec}(λ)ε[−αr′_{sys}(θ;λ)−k₀⁻¹R′∇²φr_{sys}(θ;λ)−kBr_{sys}(θ;λ)]}, (99)

where the polychromatic system function (rocking curve) is defined as:

r_{sys,poly}(θ)≡∫dλr_{sys}(θ;λ)S_{in,spec}(λ). (100)

It is convenient to choose the ‘central’ wavelength λ₀=λ₀(x,y) such that the integral over λ in eq. (100) is zero. Then the image formation in the polychromatic geometrical-optics approximation is described by the following simple formula:

M²I_{det}(Mx,My;Δx)≅S_{in,spat}(x,y)exp[−2B(x,y;λ₀)]r_{sys,poly}[θ₀−α(x,y;λ₀)]×[1−k₀⁻¹R′∇²φ(x,y;λ₀)]. (101)

One practically important case involves a narrow spectrum of the incident beam (in accordance with the assumption above). In this case, the rocking curve and its derivative are even functions of a small wavelength shift AA, with respect to the wavelength λ_{T} for which the Talbot self-imaging condition is satisfied. If the spectrum distribution S_{in,spec}(λ) is an even function with respect to some wavelength λ_{c} (this is the mean wavelength in the spectrum) then by choosing λ_{T}=λ_{c}, the integral in eq. (99) is equal to zero for all refraction angles α if the wavelength λ₀ is chosen to be equal to λ_{c}. Then applying eq. (101) to the reconstruction of the refraction angle distribution α(x,y) and the absorption function B(x,y), both these reconstructed distributions correspond to the wavelength λ_{c}.

### Polychromatic Weak-Object Phase and Amplitude Retrieval

Eq. (87) describes a monochromatic image formation for the “weak” object. In order to proceed further it is convenient to introduce the following monochromatic phase and amplitude transfer functions of the imaging system,

\hat{T}_{φ}(u,v;λ,Δx)≡i[\hat{T}_{sys}(u,v,0,0;λ,Δx)],

\hat{T}_{B}(u,v;λ,Δx)≡\hat{T}_{sys}(u,v,0,0;λ,Δx)+\hat{T}*_{sys}(−u,−v,0,0;λ,Δx). (102)

Eq. (87) can then be rewritten in the more compact form:

Ŝ_{det}(u/M,v/M,λ;Δx)/ S̅₀(λ)≅r_{sys}(Δx/R′;λ)δ(u)δ(v)+\hat{φ}(u,v,λ)\hat{T}_{φ}(u,v;Δx)−\hat{B}(u,v,λ)\hat{T}_{B}(u,v;λ,Δx). (103)

As in the previous section, a narrow spectrum of the incident beam, Δλ/λ<0.1, is assumed, which is far from the absorption edges of the materials constituting the object and the gratings. In addition a spatially uniform incident beam is assumed, so that

Sᵢₙ(x,y,λ)=Sᵢₙ(λ) and φᵢₙ(x,y,λ)=const, (104)

and therefore φ and B are the phase and attenuation induced by the object only. Presenting the averaged transmittance of the object as

$${\overline{I}}_{obj} ( λ ) = exp [ - 2 \tilde{B} ( λ ) ] \approx exp [ - 2 \tilde{B} ( {λ}_{0} ) ( 1 + \tilde{k} ɛ ) ] \approx {{\tilde{I}}_{obj} ( {λ}_{0} ) [ 1 - 2 \tilde{k} \tilde{B} ( {λ}_{0} ) ɛ ]}^{′}$$

eq. (103) then transforms to

Ŝ_{det}(u/M,v/M,λ;Δx)/[Sᵢₙ(λ)Ī_{obj}(λ₀)]≅r_{sys}(Δx/R′;λ)δ(u)δ(v)+\hat{φ}(u,v,λ₀)\hat{T}_{φ}(u,v;λ,Δx)−\hat{B}(u,v,λ₀)\hat{T}_{B}(u,v;λ,Δx)+ε{\hat{φ}(u,v,λ₀)\hat{T}_{φ}(u,v;λ,Δx)−[Bk]̂(u,v,λ₀)\hat{T}_{B}(u,v;λ,Δx)−2\tilde{k}\tilde{B}(λ₀)r_{sys}(Δx/R′;λ)δ(u)δ(v)}, (105)

where [Bk]̂(u, v, λ₀) is the Fourier transform of the product B(x, y, λ₀)k(x, y) over the spatial coordinates x and y. Integrating eq. (105) over wavelength one obtains

Î_{det}(u/M,v/M;Δx)/Ī_{obj}(λ₀)≅r_{sys,poly}(Δx/R′)δ(u)δ(v)+\hat{φ}(u,v,λ₀)\hat{T}_{φ,poly}(u,v;Δx)−\hat{B}(u,v,λ₀)\hat{T}_{B,poly}(u,v;Δx)dλS_{in,spec}(λ)ε{\hat{φ}(u,v,λ₀)\hat{T}_{φ}(u,v;λ,Δx)−[Bk]̂(u,v,λ₀)\hat{T}_{B}(u,v;λ,Δx)−2\tilde{k}\tilde{B}(λ₀)r_{sys}(Δx/R′;λ)δ(u)δ(v)},

where

r_{sys,poly}(θ)≡∫dλr_{sys}(θ;λ)S_{in,spec}(λ),

\hat{T}_{φ,poly}(u,v;Δx)≡∫dλSᵢₙ(λ)\hat{T}_{φ}(u,v;λ,Δx),

\hat{T}_{B,poly}(u,v;Δx)≡∫dλSᵢₙ(λ)\hat{T}_{B}(u,v;λ,Δx).

If the spectrum of the incident beam is symmetric with respect to some wavelength λ_{c} then choosing λ₀=λ_{c} in the previous equation one obtains the following equation for the detected intensity distribution

Î_{det}(u/M,v/M;Δx)/Ī_{obj}(λ_{c})≅r_{sys,poly}(Δx/R′)δ(u)δ(v)+\hat{φ}(u,v,λ_{c})\hat{T}_{φ,poly}(u,v;Δx)−\hat{B}(u,v,λ_{c})\hat{T}_{B,poly}(u,v;Δx) (106)

Eq. (106) is identical to the corresponding monochromatic equation (written for λ=λ_{c}) with the only difference that the system function and the transfer functions are not monochromatic but integrated over the incident spectrum.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in Australia or any other country.

### REFERENCES

[1] Bonse U and Hart M 1965 Appl. Phys. Lett. 6 155-6
[2] Ando M and Hosoya S 1972 Proceedings of the International Conference of X-Ray Optics and Microanalysis (edited by Shinoda G, Kohra K and Ichinokawa T, University of Tokyo Press, Tokyo) 63
[3] Momose A 1995 Nucl. Instrum. Methods A 352 622-8
[4] Förster E, Goetz K and Zaumseil P 1980 Krist. Tech. 15 937-45
[5] Somenkov V A, Tkalich A K and Shilstein S S 1991 Soy. Phys. Tech. Phys. 61 197-201
[6] Ingal V N and Beliaevskaya E A 1995 J. Phys. D: Appl. Phys. 28 2314-7
[7] Ingal V N, Beliaevskaya E A anf Efanov V P 1995 U.S. Pat. No. 5,579,363
[8] Davis T J, Gao D, Gureyev T E, Stevenson A W and Wilkins S W 1995 Nature (London) 373 595-8
[9] Wilkins S W 1993 Australian Patent Application No. 0583/93 (16 Aug. 1993); International Patent Application No. PCT/AU94/00480; U.S. Pat. Nos. 5,802,137 and 5,850,425
[10] Clauser J F 1998 U.S. Pat. No. 5,812,629
[11] David C, Nöhammer B, Solak H H and Ziegler E 2002 Appl. Phys. Lett. 81 3287-9
[12] Momose A, Kawamoto S, Koyama I, Hamaishi Y, Takai K and Suzuki Y 2003 Jpn. J. Appl. Phys. 42 L866-8
[13] David C 2004 European Patent Application No. EP 1 447 046; International Patent Application Publication No. WO 2004/071298; Australian Patent Application No. AU 2003/275964
[14] Weitkamp T, Nöhammer B, Diaz A, David C and Ziegler E 2005 Appl. Phys. Lett. 86 054101
[15] David C, Weitkamp T, Pfeiffer F 2006 European Patent Application No. EP 1 731 099; International Patent Application Publication No. WO 2006/131235
[16] Pfeiffer F, Weitkamp T, Bunk O and David C 2006 Nature Physics 2 258-61
[17] Momose A, Yashiro W, Takeda Y, Suzuki Y and Hattori T 2006 Jpn. J. Appl. Phys. 45 5254-62
[18] Takeda Y, Yashiro W, Suzuki Y, Aoki S, Hattori T and Momose A 2007 Jpn. J. Appl. Phys. 46 L89-L91
[19] Snigirev A, Snigireva I, Kohn V, Kuznetsov S and Schelokov I 1995 Rev. Sci. Instrum. 66 5486-92
[20] Wilkins S W 1995 Australian Patent Application No. 2112/95 (28 Mar. 1995); International Patent Application No. PCT/AU96/00178; U.S. Pat. No. 6,018,564
[21] Wilkins S W, Gureyev T E, Gao D, Pogany A and Stevenson A W 1996 Nature (London) 384 335-8
[22] Cloetens P, Barrett R, Baruchel J, Guigay J-P and Schlenker M 1996 J. Phys. D: Appl. Phys. 29 133-46
[23] M. V. Fedoryuk, “The stationary phase method and preudodifferential operators,” Russ. Math. Surveys 26, 65-115 (1971)
[24] T. E. Gureyev, Ya. I. Nesterets, D. M. Paganin, A. Pogany and S. W. Wilkins, “Linear algorithms for phase retrieval in the Fresnel region. 2. Partially coherent illumination,” Opt. Commun. 259, 569-580 (2006)
[25] L. Mandel and E. Wolf, Optical Coherence and Quantum optics (Cambridge University Press, Cambridge, 1995)
[26] Ya. I. Nesterets, P. Coan, T. E. Gureyev, A. Bravin, P. Cloetens and S. W. Wilkins, “On qualitative and quantitative analysis in analyser-based imaging,” Acta Cryst. A 62, 296-308 (2006)
[27] T. Weitkamp, A. Diaz, C. David, F. Pfeiffer, M. Stampanoni, P. Cloetens and E. Ziegler, “X-ray phase imaging with a grating interferometer,” Optics Express 13, 6295-6304 (2005)
[28] T. Weitkamp, C. David, C. Kottler, O. Bunk and F. Pfeiffer, “Tomography with grating interferometers at low-brilliance sources,” Proc. SPIE 6318, 63180S (2006)
[29] A. Momose, W. Yashiro, Y. Takeda, Y. Suzuki and T. Hattori, “Phase Tomography by X-ray Talbot Interferometry for Biological Imaging,” Jpn. J. Appl. Phys. 45, 5254-5262 (2006)
[30] Ya. I. Nesterets and S. W. Wilkins “Phase-contrast imaging using a scanning-double-grating configuration,” Opt. Express 16, 5849-5867 (2008).

1. A phase-contrast imaging apparatus for imaging an object, comprising:
a radiation source;
a first diffracting optical element located to receive radiation from said source;
a second diffracting optical element located after said first optical element;
a spatially resolving detector for detecting radiation from the source that has propagated through the object and been diffracted sequentially by the first optical element and the second optical element; and
an actuator for providing a relative translation of said first and second optical elements with respect to and across a propagation direction of radiation transmitted from said source to said detector;
wherein said actuator is configured to provide said relative translation of said first optical element at a first speed and said relative translation of said second optical element at a second speed being said first speed times a magnification factor of said apparatus.

2. The apparatus as claimed in claim 1, wherein said magnification factor is the ratio of the distance between said source and said second optical element to the distance between said source and said first optical element.

3. The apparatus as claimed in claim 1, wherein said magnification factor is two and said actuator is configured to translate said second optical element at twice said speed of said first optical element.

4. The apparatus as claimed in claim 1, wherein said actuator is configured to effect said relative translation by linearly translating said first and second optical elements, or by linearly translating said object and said detector.

5. The apparatus as claimed in claim 1, wherein said actuator is configured to rotate said first and second optical elements about said source to effect said relative translation of said first and second optical elements with respect to said propagation direction.

6. The apparatus as claimed in claim 1, wherein said actuator is configured to rotate said object and detector about said source to effect said relative translation of said first and second optical elements with respect to said propagation direction.

7. The apparatus as claimed in claim 1, further comprising an additional optical element comprising an amplitude optical element located between said source and said first optical element in order to provide an array of small sources.

8. The apparatus as claimed in claim 1, wherein said source has an effective size in the self-image plane of said first optical element that is less than a quarter of a period of said self-image.

9. The apparatus as claimed in claim 1, wherein said detector has a resolution substantially equal to said effective size of said source in the self-image plane of said first optical element.

10. The apparatus as claimed in claim 1, wherein said apparatus is optimised according to signal-to-noise ratio.

11. The apparatus as claimed in claim 10, wherein said signal-to-noise ratio is optimised by selection of any one or more of: grating periodicity of said first diffracting optical element, grating periodicity of said second diffracting optical element and magnification.

12. A phase-contrast imaging method for imaging an object, comprising:
irradiating said object with a radiation source;
detecting radiation from said source that has propagated through said object, a first diffracting optical element and a second diffracting optical element; and
providing a relative translation of said first and second optical elements with respect to and across a propagation direction of radiation transmitted from said source to said detector, said first optical element being translated at a first speed and said second optical element at a second speed being said first speed times a magnification factor defined by said relative positions of said source, said first optical element and said second optical element.

13. The method as claimed in claim 12, wherein said magnification factor is two and said method includes translating said second optical element at twice said speed of said first optical element.

14. The method as claimed in claim 12, comprising rotating said first and second optical elements about said source to effect said relative translation of said first and second optical elements with respect to said propagation direction.

15. The method as claimed in claim 12, comprising rotating said object and detector about said source to effect said relative translation of said first and second optical elements with respect to said propagation direction.

16. The method as claimed in claim 12, comprising optimising said imaging using signal-to-noise ratio as an optimisation parameter.

17. The method as claimed in claim 16, including optimising said imaging includes varying any one or more of: grating periodicity of said first diffracting optical element, grating periodicity of said second diffracting optical element and magnification.

18. The method as claimed in claim 12, comprising performing phase or amplitude retrieval using any one or more of: a geometrical optics approximation, a weak-object approximation, a polychromatic analogue of a diffraction-enhanced image method, and a polychromatic weak-object-based method.

19. A method of creating a differential phase-contrast, a dark-field phase-contrast or a bright-field phase-contrast image of an object, comprising:
irradiating sequentially a first diffracting optical element and a second diffracting optical element with a radiation source;
detecting radiation that has been diffracted by said first optical element and said second optical element;
offsetting said first and second optical elements; and
providing a relative translation of said first and second optical elements with respect to and across a propagation direction of radiation transmitted from said source to said detector, said first optical element being translated at a first speed and said second optical element at a second speed being said first speed times a magnification factor defined by said relative positions of said source, said first optical element and said second optical element.

20. The method as claimed in claim 19, including switching the orientation of said first and second optical elements to obtain a plurality of phase-contrast images of said object.

21. A phase-contrast imaging apparatus for imaging an object, wherein said apparatus is optimised according to signal-to-noise ratio.

22. The apparatus as claimed in claim 21, wherein said apparatus is optimised according to signal-to-noise-ratio with respect to a set of optimization parameters.

23. The apparatus as claimed in claim 22, wherein said set of optimization parameters includes a grating pitch of said first diffracting optical element, a grating pitch of said second diffracting optical element and a magnification of an image of said object.

24. A phase-contrast imaging method for imaging an object, comprising optimising said imaging according to signal-to-noise ratio.

25. The method as claimed in claim 24, comprising optimising said imaging according to signal-to-noise ratio with respect to a set of optimization parameters.

26. The method as claimed in claim 25, wherein said set of optimization parameters includes a grating pitch of said first diffracting optical element, a grating pitch of said second diffracting optical element and a magnification of an image of said object.

27. A method of deriving wave-amplitude and phase information from a plurality of diffraction images of an object collected with a scanning-grating-based imaging apparatus at different shift values, comprising employing a shift-invariant propagation function of said imaging system corresponding to said imaging apparatus and expressible in the general form:
T_{sys}(x,y,x′,y′;λ,Δx,R′)≡gᵢₙ(x′−x,y′−y,λ)P_{R′}(x,y)P*_{R′}(x′,y′)G(x−Δx,x′−Δx),
where Δx is a shift value, gᵢₙ(x′−x, y′−y, λ) is a spectral degree of coherence of radiation from a radiation source incident on a first diffracting optical element of said imaging apparatus having period d₁ and complex transmission function t₁(x) located to receive radiation from said source, P_{R′}(x, y)≡(iλR′)⁻¹×exp[iπ(x²+y²)/(λR′)] is a paraxial approximation for a two-dimensional free-space propagator at an effective distance R′=RM⁻²(M−1) between said first optical element and a second diffracting optical element of said imaging apparatus having real-valued transmittance function T₂ located at a distance R after said first optical element, M is a magnification of said imaging apparatus, and
$$G ( x , {x}^{′} ) ≡ {d}_{1}^{- 1} {\int }_{0}^{{d}_{1}} d {Xt}_{1} ( X - x ) {t}_{1}^{*} ( X - {x}^{′} ) {T}_{2} ( MX ) .$$

28. The method as claimed in claim 27, wherein said images are collected at deflection angles that are small compared to an angular period of said propagation function.

29. The method as claimed in claim 27, wherein said phase information comprises phase-gradient information.

30. (canceled)

31. A method for deriving wave-amplitude information and phase-gradient information from a plurality of diffraction images of an object collected with a scanning double-grating-based imaging apparatus, comprising:
employing a system function that corresponds to said imaging apparatus and is expressible in the general form:
r_{sys}[(Δx/R′);λ]≡\hat{T}_{sys}(0,0,0,0;λ,Δx,R′),
where Δx/R′ defines a working point on said system function and \hat{T}_{sys} is the Fourier transform of a system propagation function corresponding to said imaging apparatus and expressible in the general form:
T_{sys}(x,y,x′,y′;λ,Δx,R′)≡gᵢₙ(x′−x,y′−y,λ)P_{R′}(x,y)P*_{R′}(x′,y′)G(x−Δx,x′−Δx),
where Δx is a shift value, gᵢₙ(x′−x, y′−y, λ) is a spectral degree of coherence of radiation from a radiation source incident on a first diffracting optical element of said imaging apparatus having period d₁ and complex transmission function t₁(x) located to receive radiation from said source, P_{R′}(x, y)≡(iλR′)⁻¹×exp[iπ(x²+y²)/(λR′)] is a paraxial approximation for a two-dimensional free-space propagator at an effective distance R′=RM⁻²(M−1) between said first optical element and a second diffracting optical element of said imaging apparatus having real-valued transmittance function T₂ located at a distance R after said first optical element, M is a magnification of said imaging apparatus, and
$$G ( x , {x}^{′} ) ≡ {d}_{1}^{- 1} {\int }_{0}^{{d}_{1}} d {Xt}_{1} ( X - x ) {t}_{1}^{*} ( X - {x}^{′} ) {T}_{2} ( MX ) ;$$
wherein said system function is periodic with an angular period d/R′ where d is the period of the Talbot self image demagnified to a plane of said first diffracting optical element;
said images have working points that allow accurate separation of wave-amplitude and phase-derivative or related information; and

32. The method as claimed in claim 31, including selecting said images to have working points that allow accurate separation of wave-amplitude and phase-derivative or related information.

33. (canceled)

34. An apparatus for obtaining wave-amplitude and phase information from a plurality of diffraction images of an object collected with a scanning-grating-based imaging apparatus at different shift values, said imaging apparatus having a first diffracting optical element with period d₁ and complex transmission function t₁(x) located to receive radiation from a radiation source and a second diffracting optical element with real-valued transmittance function T₂ located at a distance R after said first optical element, the apparatus comprising:
a propagation function module configured to employ a shift-invariant propagation function that corresponds to said imaging apparatus and is expressible in the general form:
T_{sys}(x,y,x′,y′;λ,Δx,R′)≡gᵢₙ(x′−x,y′−y,λ)P_{R′}(x,y)P*_{R′}(x′,y′)G(x−Δx,x′−Δx),
where Δx is a shift value, gᵢₙ(x′−x, y′−y, λ) is a spectral degree of coherence of radiation from a radiation source incident on said first diffracting optical element, P_{R′}(x, y)≡(iλR′)⁻¹ exp[iπ(x²+y²)/(λR′)] is a paraxial approximation for a two-dimensional free-space propagator at an effective distance R′=RM⁻²(M−1) between said first and second diffracting optical elements, M is a magnification of said imaging apparatus, and
$$G ( x , {x}^{′} ) ≡ {d}_{1}^{- 1} {\int }_{0}^{{d}_{1}} d {Xt}_{1} ( X - x ) {t}_{1}^{*} ( X - {x}^{′} ) {T}_{2} ( MX ) .$$

35. (canceled)

36. An apparatus for obtaining wave-amplitude information and phase-gradient information from a plurality of diffraction images of an object that have working points that allow accurate separation of wave-amplitude and phase-derivative or related information, said images having been collected with a scanning double-grating-based imaging apparatus having a first diffracting optical element with period d₁ and complex transmission function t₁(x) located to receive radiation from a radiation source and a second diffracting optical element with real-valued transmittance function T₂ located at a distance R after said first optical element, the apparatus comprising:
a system function module configured to employ a system function that corresponds to said imaging apparatus and is expressible in the general form:
r_{sys}[(Δx/R′);λ]≡\hat{T}_{sys}(0,0,0,0;λ,Δx,R′),
where Δx/R′ defines a working point on said system function and \hat{T}_{sys} is the Fourier transform of a shift-invariant system propagation function corresponding to said imaging apparatus; and
a propagation function module configured to employ said system propagation function, said system propagation function being expressible in the general form:
T_{sys}(x,y,x′,y′;λ,Δx,R′)≡gᵢₙ(x′−x,y′−y,λ)P_{R′}(x,y)P*_{R′}(x′,y′)G(x−Δx,x′−Δx),
where Δx is a shift value, gᵢₙ(x′−x, y′−y, λ) is a spectral degree of coherence of radiation from a radiation source incident on a first diffracting optical element of said imaging apparatus, P_{R′}(x, y)≡(iλR′)⁻¹×exp[iπ(x²+y²)/(λR′)] is a paraxial approximation for a two-dimensional free-space propagator at an effective distance R′=RM⁻²(M−1) between said first optical element and a second diffracting optical element of said imaging apparatus, M is a magnification of said imaging apparatus, and
$$G ( x , {x}^{′} ) ≡ {d}_{1}^{- 1} {\int }_{0}^{{d}_{1}} d {Xt}_{1} ( X - x ) {t}_{1}^{*} ( X - {x}^{′} ) {T}_{2} ( MX ) ;$$
wherein said system function is periodic with an angular period d/R′ where d is the period of the Talbot self image demagnified to a plane of said first diffracting optical element.

37. (canceled)
